(19) United States
(12) Patent Application Publication
(10) Pub. No.: US 2022/0410875 A1
(43) Pub. Date: Dec. 29, 2022

(54) DRIVING ASSISTANCE DEVICE, DRIVING ASSISTANCE METHOD AND NON-TRANSITORY COMPUTER-READABLE MEDIUM

(71) Applicant: PANASONIC INTELLECTUAL PROPERTY MANAGEMENT CO., LTD., Osaka (JP)

(72) Inventor: Noriyuki TANI, Kanagawa (JP)

(73) Assignee: PANASONIC INTELLECTUAL PROPERTY MANAGEMENT CO., LTD., Osaka (JP)

(21) Appl. No.: 17/900,096

(22) Filed: Aug. 31, 2022

Related U.S. Application Data
(63) Continuation of application No. PCT/JP2021/007788, filed on Mar. 1, 2021.

(30) Foreign Application Priority Data
Mar. 3, 2020 (JP) 2020-036297

(51) Int. Cl. B60W 30/06; B60W 60/00

(52) U.S. Cl. CPC B60W 30/06; B60W 60/001; B60W 2540/18; B60W 2520/00; B60W 10/20

(57) ABSTRACT

A driving assistance device is configured to assist parking of a vehicle by automated driving along a route on which a driver of the vehicle parks the vehicle in a parking area by manual driving. The driving assistance device includes a processor. The processor is configured to: acquire a steering angle measured value during manual driving of the vehicle; acquire a steering angle control range during automated driving of the vehicle; and determine a vehicle speed command value during automated driving of the vehicle based on a limit value of the steering angle control range in a case in which the steering angle measured value falls outside the steering angle control range.

### CROSS-REFERENCE TO RELATED APPLICATIONS

This is a continuation of International Application No. PCT/JP2021/007788 filed on Mar. 1, 2021, and claims priority from Japanese Patent Application No. 2020-036297 filed on Mar. 3, 2020, the entire content of which is incorporated herein by reference.

### TECHNICAL FIELD

The present disclosure relates to a driving assistance device and a driving assistance method for assisting driving of a vehicle.

### BACKGROUND ART

In the related art, it is known that when a vehicle is parked in a predetermined parking lot, a steering angle or the like of a steering mechanism (a steering wheel) of the vehicle is appropriately driven and controlled by automated driving. For example, it is known that a measured value such as a steering angle of the vehicle when a driver drives the vehicle (hereinafter, also referred to as manual driving) is learned in advance, and the vehicle is parked by automated driving in accordance with the measured value such as the steering angle of the vehicle learned next time and thereafter (for example, see JP-B2-6022447).

### SUMMARY OF INVENTION

According to one aspect of the present disclosure, there is provided a driving assistance device for assisting parking of a vehicle by automated driving along a route on which a driver of the vehicle parks the vehicle in a parking area by manual driving. The driving assistance device includes a processor, in which the processor acquires a steering angle measured value during manual driving of the vehicle, acquires a steering angle control range during automated driving of the vehicle, and determines a vehicle speed command value during automated driving of the vehicle based on a limit value of the steering angle control range in a case in which the steering angle measured value falls outside the steering angle control range.

According to another aspect of the present disclosure, there is provided a driving assistance method for assisting parking of a vehicle by automated driving along a route on which a driver of the vehicle parks the vehicle in a parking area by manual driving. The driving assistance method includes acquiring a steering angle measured value during manual driving of the vehicle, acquiring a steering angle control range during automated driving of the vehicle, and determining a vehicle speed command value during automated driving of the vehicle based on a limit value of the steering angle control range in a case in which the steering angle measured value falls outside the steering angle control range. According to yet another aspect of the disclosure, there is provided a non-transitory computer-readable medium that stores a computer program, the computer program, when executed by a processor, causing a computer to perform a process for assisting parking of a vehicle by automated driving along a route on which a driver of the vehicle parks the vehicle in a parking area by manual driving, the process including: acquiring a steering angle measured value during manual driving of the vehicle; acquiring a steering angle control range during automated driving of the vehicle; and determining a vehicle speed command value during automated driving of the vehicle based on a limit value of the steering angle control range in a case in which the steering angle measured value falls outside the steering angle control range.

### BRIEF DESCRIPTION OF DRAWINGS

FIG. 1 is a block diagram showing a control configuration of a vehicle according to a first embodiment.

FIG. 2 is a flowchart showing an example of a processing executed by a steering control unit.

FIG. 3A is a flowchart showing a first example of a processing executed by a speed control unit.

FIG. 3B is a flowchart showing a second example of a processing executed by the speed control unit.

FIG. 3C is a flowchart showing an example of a constraint condition determination processing.

FIG. 3D is a diagram showing an example of a relationship between a vehicle speed and a turning angular velocity normalized by the vehicle speed.

FIG. 4 is a block diagram showing a control configuration of a vehicle according to a second embodiment.

FIG. 5A is a flowchart showing a second operation example of a driving plan generation unit.

FIG. 5B is a flowchart showing a first operation example of the driving plan generation unit.

FIG. 6 is a block diagram showing a control configuration of a vehicle according to a third embodiment.

FIG. 7A is a flowchart showing a first example of a processing executed by a steering control unit.

FIG. 7B is a flowchart showing a second example of a processing executed by the steering control unit.

FIG. 7C is a flowchart showing an example of an average curvature determination processing.

FIG. 7D is a flowchart showing an example of a turning actual result determination processing.

FIG. 8 is a block diagram showing a control configuration of a vehicle according to a fourth embodiment.

FIG. 9 is a flowchart showing a processing executed by a steering control unit.

FIG. 10 is a schematic diagram showing a difference between a steering angle control range during manual driving of a vehicle and a steering angle control range during automated driving.

FIG. 11 is a schematic diagram showing a steering trajectory at a maximum steering angle by manual driving and automated driving of a vehicle.

### DESCRIPTION OF EMBODIMENTS

Hereinafter, an embodiment will be described in detail with reference to the drawings as appropriate. Unnecessarily detailed description may be omitted. For example, detailed description of a well-known matter or repeated description of substantially the same configuration may be omitted. This is to avoid unnecessary redundancy in the following description and to facilitate understanding for those skilled in the art. The accompanying drawings and the following description are provided for those skilled in the art to fully understand the present disclosure, and are not intended to limit the subject matter described in the claims.

For example, a “unit” or a “device” in an embodiment is not limited to a physical configuration simply implemented by hardware, and includes a configuration in which a function of the configuration is implemented by software such as a program. In addition, a function of one configuration may be implemented by two or more physical configurations, or functions of two or more configurations may be implemented by, for example, one physical configuration.

### Introduction to Embodiments of the Present Disclosure

Specifically, in a learning mode, a driver assistance device disclosed in Patent JP-B2-6022447 stores reference data (for example, data of a steering angle) about surroundings of a parking space using a sensor device of the driver assistance device when a driver drives an automobile and parks the automobile in the parking space. In the learning mode, the driver assistance device stores a reference target position where the automobile arrives, and stores data including information about the reference target position. In a subsequent driving mode (for example, an automated driving mode) different from the learning mode, the driver assistance device stores sensor data (for example, data of a steering angle) of a sensor device and compares the sensor data with reference data. The driver assistance device determines a current position of the automobile relative to the reference target position by identifying surroundings of the parking space using the stored sensor data according to the comparison result. According to the current position of the automobile relative to the reference target position, the driver assistance device determines a parking route for parking the automobile along the route in the parking space from the current position. That is, the driver assistance device acquires information such as a steering angle during manual parking, and assists a driver to park a vehicle during later automated parking by learning the manual parking.

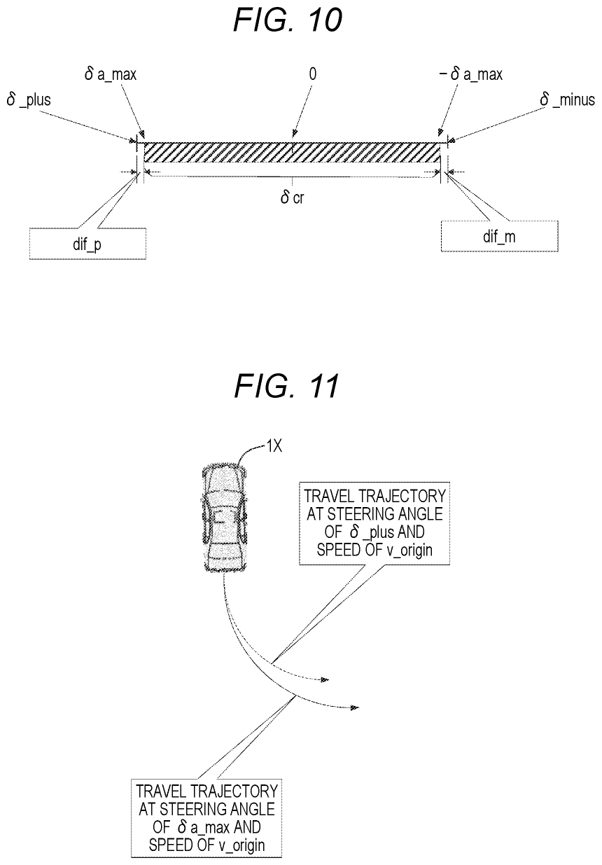

In manual driving, a steering angle control range of a vehicle has individual variations depending on the vehicle, and thus the control range is not uniformly determined at present. As described above, there are individual variations in manual driving, while a steering angle control range of a vehicle during automated driving is uniformly determined. Therefore, the steering angle control range of a vehicle during automated driving is set to be smaller than the steering angle control range of a vehicle during manual driving (see FIG. 10).

In FIG. 10, a control range of a steering angle δa during automated driving is a range from −δa_max to +δa_max, and is, for example, a range from −580 degrees to +580 degrees. A control range during manual driving is a range from δ_minus to δ_plus, and is, for example, a range from −600 degrees to +600 degrees. Therefore, in manual driving, there is a margin of dif_p at an upper limit side and a margin of dif_m at a lower limit side for a steering angle as compared with automated driving.

Therefore, when a vehicle speed of a vehicle is constant at v_origin, a travel trajectory at a maximum steering angle in automated driving is larger than a travel trajectory at a maximum steering angle in manual driving (see FIG. 11). As a result, when a vehicle is driven in a narrow space such as a parking lot, the number of steering turns increases, and a time up to when traveling is completed by automated driving increases.

In JP-B2-6022447, when driving during manual driving is performed without considering a steering angle control range during automated driving, a steering angle control range at the time of manual driving may be wider than a set steering angle control range during automated driving. In this case, in automated driving, it is difficult to perform automated driving in accordance with a steering angle and a travel trajectory (route) of manual driving. For example, in a case where a driver performs steering at a steering angle of +600 degrees at the time of parking in manual driving, since the steering angle has a control range of only +580 degrees in automated driving, during automated driving, it is not possible to reproduce a parking trajectory generated during manual driving.

A driving assistance device and a driving assistance method capable of performing automated driving in accordance with a driving plan including a steering plan in which a steering angle exceeds a steering angle control range assumed in automated driving will be described in the following embodiments.

### First Embodiment

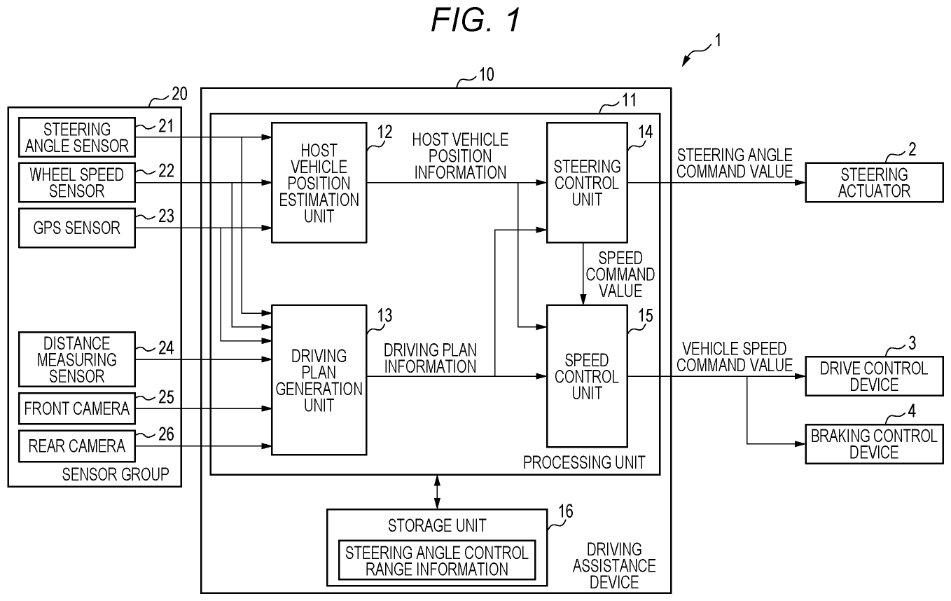

First, a first embodiment will be described with reference to FIGS. 1 to 3D.

<Configuration of Driving Assistance Device>

A control configuration of a vehicle 1 including a driving assistance device 10 according to the present embodiment will be described with reference to FIG. 1. FIG. 1 is a block diagram showing a control configuration of the vehicle 1 according to the present embodiment.

The vehicle 1 includes a driving assistance device 10, a sensor group 20, a steering actuator 2, a drive control device 3, a braking control device 4, a drive motor (not shown), a braking mechanism (not shown), and a communication unit (not shown). A driving assistance system includes the driving assistance device 10 having an electrical configuration provided in the vehicle 1, the sensor group 20, the steering actuator 2, the drive control device 3, the braking control device 4, and the communication unit.

The vehicle 1 includes a pair of front wheels that are rotatably supported by a front axle at a front side, and a pair of rear wheels that are rotatably supported by a rear axle at a rear side. The vehicle 1 turns when the front wheels are steered in a width direction of the vehicle 1 by a steering mechanism to be described later. Although the vehicle 1 has four wheels as described above in the present embodiment, the present disclosure is not limited thereto.

An example of the drive motor is an electric motor, and the drive motor is not limited thereto. Alternatively, the drive motor may be an internal combustion engine or a combination of an internal combustion engine and an electric motor. The drive motor has a rotation mechanism, and rotationally drives the rotation mechanism, thereby applying kinetic energy to the vehicle 1 to cause the vehicle 1 to travel. The braking mechanism is a mechanism for braking wheels, and is, for example, a transmission, a brake mechanism, or the like. The braking mechanism accelerates, decelerates, or stops the vehicle 1 by applying a torque (a braking force) for deceleration to a drive shaft (not shown) of a wheel.

The communication unit controls transmission and reception of data via a communication network (for example, CAN), and connects components of the vehicle 1 in a bidirectional communication manner. For example, the communication unit transmits and receives measured values measured by respective sensors included in the sensor group 20 via the communication network. Then, the communication unit transmits the received measured values to the driving assistance device 10. The driving assistance device 10 performs various types of control related to driving assistance of the vehicle 1 based on the received measured values.

Some or all of the driving assistance device 10, the drive control device 3, and the braking control device 4 are implemented by individual electronic control units (ECUs). Alternatively, the driving assistance device 10, the drive control device 3, and the braking control device 4 may be implemented by one ECU. The ECU includes a processing unit and a storage unit, and implements various functions by the processing unit reading and executing various programs stored in the storage unit. Alternatively, the ECU may be implemented by a microcomputer, an integrated circuit, an application specific integrated circuit (ASIC), a programmable logic device (PLD), or a field-programmable gate array (FPGA) and implements various functions.

The processing unit 11 is, for example, a processor, and may be replaced with other terms such as a controller and a central processing unit (CPU). The storage unit 16 is implemented by a read only memory (ROM), a random access memory (RAM), or a combination of a ROM and a RAM, and stores information such as programs and data for implementing the functions of the ECU. The RAM is implemented by, for example, a volatile memory.

The steering actuator 2 is an electric motor, and constitutes a part of a steering mechanism in which a steering wheel is disposed at a tip end of the steering actuator. The steering actuator 2 is disposed on a steering shaft (not shown) or a rack shaft (not shown) of the steering wheel of the vehicle 1, and determines a steering angle of the steering mechanism by rotating the steering shaft or the rack shaft at a predetermined angle around a predetermined axis. The driving assistance device 10 controls the steering angle of the steering mechanism by transmitting a steering angle command value to the steering actuator 2. As a result, the driving assistance device 10 controls the steering actuator 2 to control a turning curvature (a degree of a large turn) of the vehicle 1 during traveling.

The drive control device 3 controls an operation of a drive driver or the like of the drive motor to appropriately control a rotation timing, a rotation speed, and the like of the drive motor, and controls a rotation speed of the drive motor. The braking control device 4 drives and controls a braking mechanism to apply a braking force to the vehicle 1. The driving assistance device 10 controls a vehicle speed by transmitting a vehicle speed command value to the drive control device 3 and the braking control device 4.

The sensor group 20 includes a steering angle sensor 21, a wheel speed sensor 22, a GPS sensor 23, a distance measuring sensor 24, a front camera 25, and a rear camera 26. The sensor group 20 may appropriately include other sensors such as a yaw rate sensor, an acceleration sensor, a millimeter wave radar, and a LIDAR. A yaw rate is an angular velocity around a vertical axis of the vehicle, and is a turning angular velocity of the vehicle.

The steering angle sensor 21 measures a steering angle of a steering wheel. The steering angle sensor 21 sets a steering angle when the vehicle 1 travels straight to a neutral position (0 degree), and transmits a rotation angle relative to the neutral position serving as a steering angle to the driving assistance device 10. The steering angle may be output with a positive (+) sign in a case where the vehicle 1 is turned to the right relative to the neutral position, and may be output with a negative (−) sign in a case where the vehicle 1 is turned to the left relative to the neutral position, and such measured values may be transmitted.

The wheel speed sensor 22 measures a rotation speed of a wheel. The wheel speed sensor 22 measures a rotation speed of a wheel, and transmits a measurement result to a host vehicle position estimation unit 12 (to be described later) and a driving plan generation unit 13 (to be described later) of the driving assistance device 10. For example, the wheel speed sensor 22 measures a pulse period of a rotor that rotates together with a wheel or a drive shaft. The wheel speed sensor 22 measures a rotation speed of the wheel based on the measured pulse period (the number of pulses per unit time). Therefore, in an extremely low speed area in which the pulse period is equal to or larger than a predetermined threshold, the accuracy of a wheel speed measured value may decrease. As a result, the accuracy of a detected value (a measured value) of a vehicle speed of the vehicle 1 may be insufficient. In the present embodiment, the driving assistance device 10 can determine a speed of the vehicle 1 based on the pulse period of the rotor in a low speed state in a narrow space such as a parking lot, so that it is possible to prevent a decrease in the detection accuracy, which will be described later.

The GPS sensor 23 receives a plurality of signals indicating a time and a position (coordinates) of each GPS satellite transmitted from a plurality of GPS satellites, and calculates a position of a body of the GPS sensor 23, that is, a position of the vehicle 1, based on the plurality of received signals. The GPS sensor 23 transmits information about the position of the vehicle 1 to the host vehicle position estimation unit 12 and the driving plan generation unit 13 of the driving assistance device 10 based on a calculation result.

The distance measuring sensor 24 radiates probe waves (sonar waves) toward the outside of the vehicle 1, receives reflected waves obtained by an obstacle reflecting the probe waves, and determines and measures the presence or absence of the obstacle and a distance to the obstacle. The distance measuring sensor 24 may be, for example, an ultrasonic sensor that transmits ultrasonic waves serving as probe waves. A plurality of distance measuring sensors 24 are provided, and for example, the distance measuring sensors 24 are respectively disposed on left and right side surfaces of front bumper and rear bumper of the vehicle 1 such that a center line of directivity is parallel to an axle direction of the vehicle 1. The distance measuring sensor 24 transmits the determination result and the measurement result to the host vehicle position estimation unit 12 and the driving plan generation unit 13 of the driving assistance device 10.

For example, the front camera 25 and the rear camera 26 are disposed above the front bumper and the rear bumper of the vehicle 1, and capture an image of an area extending in a predetermined angular range in front of and behind the vehicle 1. Each of the front camera 25 and the rear camera 26 is disposed such that an optical axis of the camera faces a road surface in front of or behind the vehicle body. For example, the front camera 25 and the rear camera 26 may be implemented by a CCD camera. The front camera 25 and the rear camera 26 transmit captured image information about a front periphery and a rear periphery of the vehicle 1 to the driving plan generation unit 13 of the driving assistance device 10. Since the vehicle 1 includes both the front camera 25 and the rear camera 26, the vehicle 1 is not limited to traveling rearward in a narrow space such as a parking lot during automated driving, and the vehicle 1 can travel forward during automated driving.

The vehicle 1 may not include some of the above-described sensors included in the sensor group 20.

The driving assistance device 10 is mounted on a vehicle body of the vehicle 1. For example, when the driving assistance device 10 is implemented by an ECU, the driving assistance device 10 includes a plurality of processing units 11 and storage units 16.

The processing unit 11 includes the host vehicle position estimation unit 12, the driving plan generation unit 13, a steering control unit 14, and a speed control unit 15. The processing unit 11 executes a processing related to the assistance of driving of the vehicle 1. The driving of the vehicle 1 includes automated driving, and may include, for example, automated traveling on a general road and automated traveling in a narrow space such as a parking lot. The automated traveling on a general road may widely include traveling on a general road such as forward traveling, rearward traveling, right turning, or left turning.

The storage unit 16 stores a steering angle control range during automated driving, driving plan information generated by the driving plan generation unit 13, likelihood information related to detection of the wheel speed sensor 22, and the like. The driving plan information includes route information that is information related to a trajectory (a route) along which the vehicle 1 is about to travel, that is, a planned travel trajectory. The driving plan information includes a steering angle at each point of the travel trajectory and a vehicle speed corresponding to the steering angle in combination (association) with each other. The driving plan information may be, for example, driving plan information acquired from an external device via a communication unit, instead of the driving plan information generated by the driving plan generation unit 13.

The host vehicle position estimation unit 12 receives measured values from the steering angle sensor 21, the wheel speed sensor 22, and the GPS sensor 23 during automated driving, and estimates a host vehicle position and a posture (orientation) relative to a reference point (for example, an origin in the world coordinate system). For example, the host vehicle position estimation unit 12 estimates the host vehicle position by sequentially calculating movement amounts based on a steering angle and a vehicle speed sequentially acquired from the steering angle sensor 21 and the wheel speed sensor 22. The host vehicle position estimation unit 12 transmits an estimation result serving as host vehicle position information to the steering control unit 14 and the speed control unit 15. The driving assistance device 10 may acquire the host vehicle position information using a method other than the above-described one.

During manual driving, the driving plan generation unit 13 receives measured values from the steering angle sensor 21, the wheel speed sensor 22, the GPS sensor 23, the distance measuring sensor 24, the front camera 25, and the rear camera 26, and generates driving plan information to be used in automated driving based on measurement information. In this case, for example, the driving plan generation unit 13 estimates a host vehicle position and a posture (orientation) based on the steering angle sensor 21, the wheel speed sensor 22, and the GPS sensor 23 in a similar manner. The driving plan generation unit 13 recognizes a relative position of the vehicle 1 in a real space and stereoscopic information (obstacle information) based on the distance measuring sensor 24, the front camera 25, and the rear camera 26. The driving plan generation unit 13 can calculate a travel start position, a travel end position, a route from the travel start position to the travel end position, and the like during automated driving based on the stereoscopic information indicating what kind of obstacle it is, the estimation described above, and the recognition described above. The driving plan generation unit 13 can generate driving plan information in accordance with each real space (for example, each parking lot) by executing such kind of calculation. The driving plan generation unit 13 transmits the generated driving plan information to the steering control unit 14 and the speed control unit 15.

Therefore, the driving plan generation unit 13 may generate driving plan information during automated driving based on a driving actual result during manual driving of the vehicle 1, that is, measured values of the sensor group 20 during manual driving. As a result, in a predetermined narrow space where the vehicle 1 is frequently parked, when driving actual results of manual driving at the time of first time parking is obtained, automated driving can be performed in second and subsequent time parking.

The steering control unit 14 transmits command values to the steering actuator 2 and the speed control unit 15 to control a behavior (for example, traveling, stopping, steering, and the like) of the vehicle 1. The steering control unit 14 acquires host vehicle position information from the host vehicle position estimation unit 12 and driving plan information from the driving plan generation unit 13. The steering control unit 14 sequentially calculates steering angle command values at points on the route from the travel start position to the travel end position of the vehicle 1 based on the acquired host vehicle position information and driving plan information. The steering control unit 14 transmits the sequentially calculated steering angle command values to the steering actuator 2.

The steering control unit 14 also acquires a steering angle control range during automated driving from the storage unit 16. The steering control unit 14 limits (restricts) a steering angle command value so as not to fall outside the steering angle control range. For example, when the steering control unit 14 determines that a result (a steering angle command value) calculated based on the host vehicle position information and the driving plan information exceeds an upper limit value or a lower limit value of the steering angle control range, the steering control unit 14 sets the steering angle command value to be the upper limit value or the lower limit value of the steering angle control range. Accordingly, the steering control unit 14 restricts a final steering angle command value so as not to fall outside the steering angle control range during automated driving.

The driving plan information may also be appropriately updated in accordance with the restriction processing, and the updated driving plan information may be stored in the storage unit 16.

When the steering control unit 14 determines that an acquired steering angle measured value falls outside the steering angle control range, the steering control unit 14 calculates a vehicle speed candidate value when the vehicle 1 is steered according to the steering angle during automated driving. The steering control unit 14 transmits the vehicle speed candidate value to the speed control unit 15.

The speed control unit 15 controls a vehicle speed of the vehicle 1 by transmitting vehicle speed command values to the drive control device 3 and the braking control device 4. Similar to the steering control unit 14, the speed control unit 15 acquires host vehicle position information from the host vehicle position estimation unit 12 and driving plan information from the driving plan generation unit 13. The speed control unit 15 sequentially calculates vehicle speed command values at points on the route from the travel start position to the travel end position based on the acquired host vehicle position information and driving plan information. Since the calculated command value may be updated, the calculated command value is also referred to as a “scheduled vehicle speed command value”. The speed control unit 15 sequentially compares the scheduled vehicle speed command value calculated by the speed control unit 15 with vehicle speed candidate values from the steering control unit 14, and determines a final vehicle speed command value. The speed control unit 15 transmits a comparison result, that is, a finally determined vehicle speed command value to the drive control device 3 and the braking control device 4. The scheduled vehicle speed command value may not be calculated by a special calculation, and may be, for example, a constant value (for example, 3 km/h) or may be equal to a vehicle speed planned value included in the driving plan information.

<Processing Flow of Steering Control Unit and Speed Control Unit>

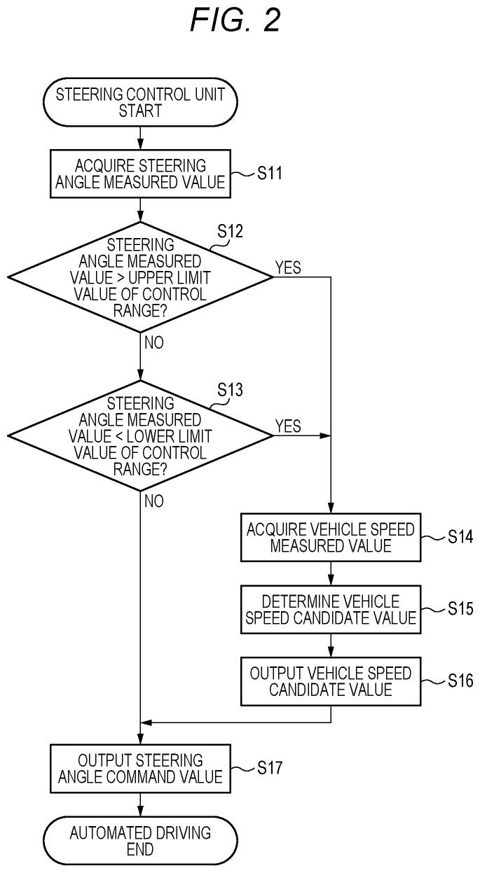

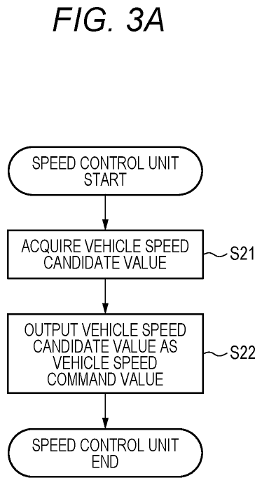

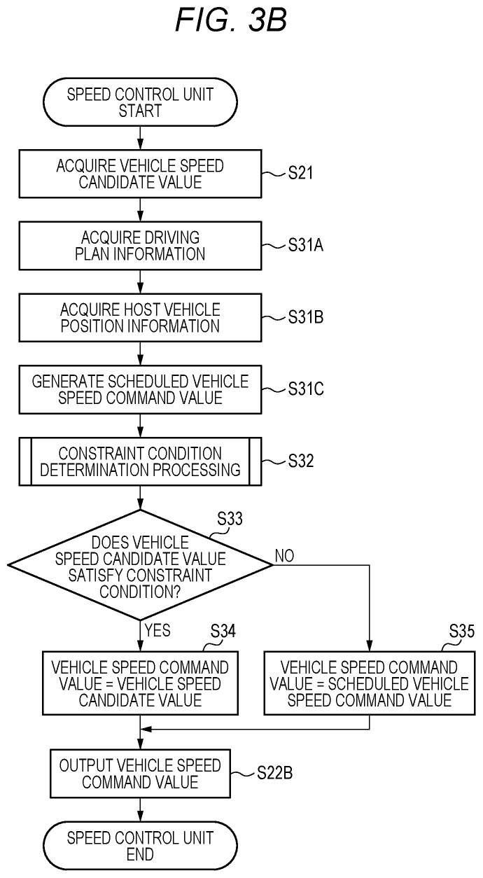

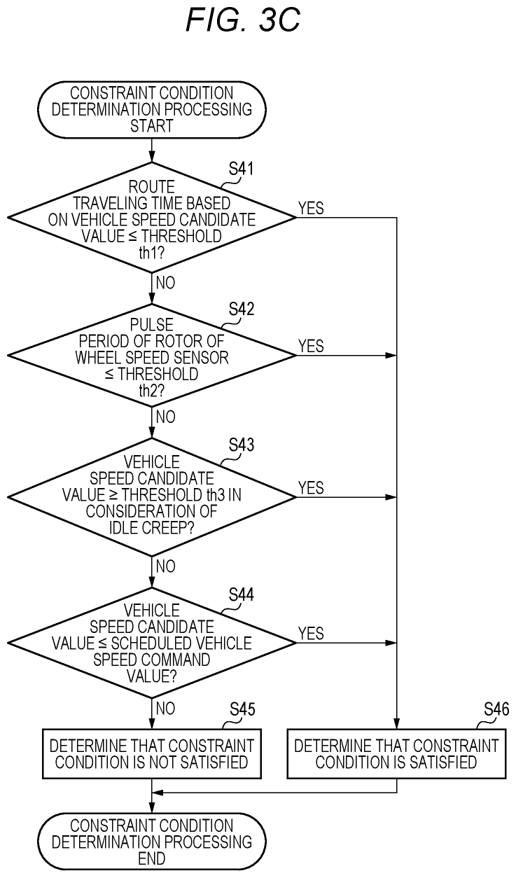

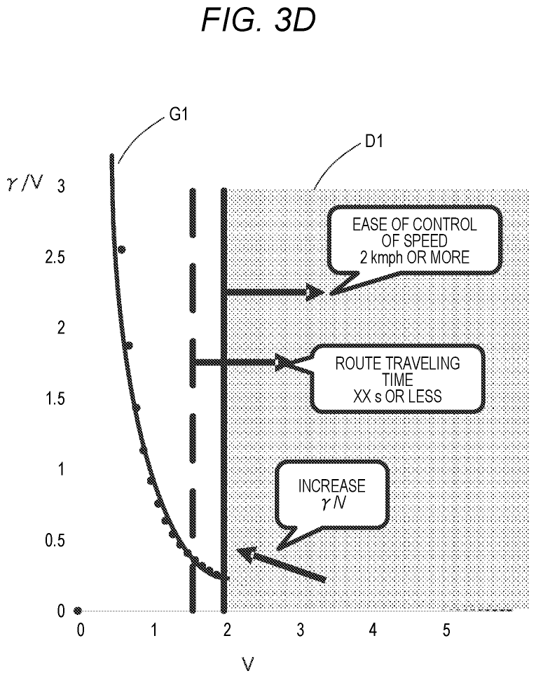

A processing flow of each of the steering control unit 14 and the speed control unit 15 will be described with reference to FIGS. 2, 3A and 3B. FIG. 2 is a flowchart showing an example of a processing executed by the steering control unit 14. FIG. 3A is a flowchart showing a first example of a processing executed by the speed control unit 15. FIG. 3B is a flowchart showing a second example of a processing executed by the speed control unit 15. When the vehicle 1 actually travels by automated driving, the steering control unit 14 and the speed control unit 15 may sequentially execute processings shown in FIGS. 2, 3A, and 3B.

When the steering control unit 14 determines that automated driving is started, the steering control unit 14 starts a processing flow shown in FIG. 2 (START). For example, the steering control unit 14 may compare a difference between the driving plan information from the driving plan generation unit 13 and a measured value of each of the GPS sensor 23, the distance measuring sensor 24, the front camera 25, and the rear camera 26, and determine that automated driving is started when the difference is equal to or smaller than a predetermined threshold. The steering control unit 14 may acquire an operation input via an operation unit provided in the vehicle 1 as an instruction to start automated driving.

The steering control unit 14 acquires a steering angle measured value measured by the steering angle sensor 21 during manual driving (S11). For example, the steering angle measured value during manual driving may be stored in the storage unit 16, and the steering control unit 14 may acquire the steering angle measured value during manual driving stored in the storage unit 16. For example, the steering control unit 14 may acquire, from the driving plan information, a steering angle planned value during automated driving corresponding to the steering angle measured value during manual driving. The steering control unit 14 may acquire a steering angle measured value during automated driving from the steering angle sensor 21 instead of the steering angle measured value during manual driving.

The steering control unit 14 reads an upper limit value of a steering angle control range stored in the storage unit 16, and determines whether the acquired measured value (actually measured value) is larger than the upper limit value (S12). As a result of the determination, when it is determined that the measured value is equal to or smaller than the upper limit value (NO in S12), the steering control unit 14 reads a lower limit value of the steering angle control range stored in the storage unit 16, and determines whether the measured value is smaller than the lower limit value (S13). That is, in step S12 and step S13, the steering control unit 14 determines whether the acquired steering angle measured value falls outside or within the steering angle control range during automated driving.

When it is determined that the acquired steering angle measured value falls outside the control range (YES in S12 or YES in S13), the steering control unit 14 acquires a wheel rotation speed measured by the wheel speed sensor 22, calculates a vehicle speed based on the wheel rotation speed, and acquires the vehicle speed as a vehicle speed measured value (S14). The steering control unit 14 determines a vehicle speed candidate value based on the vehicle speed measured value and the upper limit value or the lower limit value of the steering angle control range (S15).

Specifically, when the vehicle speed candidate value is calculated, a yaw motion model is set in the steering control unit 14 as a control model (a dynamic model) of the vehicle 1. Information of the yaw motion model may be stored in, for example, the storage unit 16. The steering control unit 14 sequentially calculates a turning angular velocity from the vehicle speed and the steering angle based on the yaw motion model. For example, when the yaw motion model is an equivalent two-wheel model, the steering control unit 14 calculates a turning angular velocity γ from a vehicle speed V and a steering angle δ according to the following Equation (1), in which γ [rad/s] is a turning angular velocity when the vehicle 1 is turned in a steady circle, V [m/s] is a vehicle speed, and δ [rad] is a steering angle. The steering angle may be the steering angle acquired in step S11. The vehicle speed may include the vehicle speed acquired in step S14. The vehicle speed may include various vehicle speeds.

When it is determined in step S12 that the acquired steering angle measured value is larger than the upper limit value of the control range, the steering control unit 14 calculates the steering angle δ by substituting the upper limit value for the steering angle δ in the Equation (1). When it is determined in step S13 that the acquired steering angle measured value is smaller than the lower limit value of the control range, the steering control unit 14 calculates the steering angle δ by substituting the lower limit value for the steering angle δ in the Equation (1). The upper limit value and the lower limit value of the steering angle control range during automated driving are also referred to as a unit steering input (δn). The turning angular velocity γ in this case is also referred to as γn.

$$\begin{matrix}[ Equation 1 ] & \\ γ = \frac{1}{\text{?} - \frac{m}{2 {l}^{2}} \cdot \frac{lf \cdot kf - lr \cdot kr}{kf \cdot kr} \cdot {V}^{2}} \cdot \frac{V}{l} \cdot δ & ( 1 )\end{matrix}$$

$$1 = 1 f + 1 r$$

$$\text{?} \text{indicates text missing or illegible when filed}$$

if distance [m] from a position of the center of gravity of the vehicle 1 to the front axle

lr: distance [m] from the position of the center of gravity of the vehicle 1 to the rear axle

m: vehicle weight

kf: cornering power at front wheel

kr: cornering power at rear wheel

The steering control unit 14 calculates the turning angular velocity γ when the steering angle δ is input for each vehicle speed V according to the Equation (1). The steering control unit 14 calculates a ratio γ/V of the turning angular velocity of the vehicle 1 to a vehicle speed measured value. The steering control unit 14 may calculate the vehicle speed V at which the value of the ratio γ/V is maximum as a vehicle speed candidate value and determine the vehicle speed candidate value. The steering control unit 14 may calculate the vehicle speed V at which the value of the ratio γ/V is maximum under a predetermined condition (range) as a vehicle speed candidate value and determine the vehicle speed candidate value.

The steering control unit 14 outputs the calculated vehicle speed candidate value to the speed control unit 15 (S16). The steering control unit 14 calculates a steering angle command value and outputs the steering angle command value to the steering actuator 2 (S17).

Here, a reason why the value of γ/V is considered when the vehicle speed candidate value is determined will be described. For example, when the turning angular velocity γ is 1 (Rad/s) and the vehicle speed V is 10 km/h, γ/V causes the vehicle 1 to travel 10 m and turns in one radian per second. When the vehicle 1 travels along a route while turning in a narrow space, a remaining distance of the route is important. In the above case, the vehicle turns in one radian per second and travels 10 m. Therefore, as compared with a case where the vehicle speed is 1 km/h, a travel distance is ten times and a remaining travel distance is ten times shorter. Therefore, it is important to consider a vehicle speed at the time of turning, and it is more beneficial than simply considering the value of γ. In this manner, the turning angular velocity γ is normalized by the vehicle speed V in consideration of a travel distance, and is used as a determination index for acquiring a vehicle speed candidate value. Therefore, the steering control unit 14 can determine whether a vehicle speed is appropriate or inappropriate based on the value of γ/V.

The yaw motion model and the equivalent two-wheel model are examples for deriving the turning angular velocity γ from the steering angle δ. Other models may be used, and, for example, a model based on a convolution neural network (CNN), a reinforcement learning model, or the like. In the Equation (1), the steering angle δ is input to derive the turning angular velocity γ. Alternatively, the turning angular velocity γ may be measured by a yaw rate sensor provided in the sensor group 200, and a measured value may be acquired. In this case, the steering control unit 14 may use the steering angle δ and the turning angular velocity γ as learning data and learn a model for deriving the turning angular velocity γ based on the steering angle δ.

Similar to the steering control unit 14, the speed control unit 15 starts (START) a processing flow shown in FIG. 3A when it is determined that traveling by automated driving is started.

The speed control unit 15 acquires a vehicle speed candidate value from the steering control unit 14 (S21). The speed control unit 15 outputs the vehicle speed candidate value to at least one of the drive control device 3 and the braking control device 4 as a vehicle speed command value (S22). Accordingly, the driving assistance device 10 can control a speed of the vehicle 1 based on the vehicle speed candidate value determined by the steering control unit 14.

Instead of FIG. 3A, the speed control unit 15 may operate in accordance with FIG. 3B. In this case, the speed control unit 15 starts (START) a processing flow shown in FIG. 3B when it is determined that traveling by automated driving is started.

The speed control unit 15 acquires a vehicle speed candidate value from the steering control unit 14 (S21). The speed control unit 15 acquires driving plan information from the driving plan generation unit 13 (S31A). The speed control unit 15 acquires host vehicle position information from the host vehicle position estimation unit 12 (S31A). The speed control unit 15 generates a scheduled vehicle speed command value of the vehicle 1 based on the driving plan information and the host vehicle position information (S31C). For example, the speed control unit 15 sequentially calculates scheduled command values at points on the route from the travel start position to the travel end position during automated driving of the vehicle 1.

The speed control unit 15 performs a constraint condition determination processing for determining whether a vehicle candidate value is adopted as a vehicle command value (S32). Details of the constraint condition determination processing will be described later. After the constraint condition determination processing, the speed control unit 15 determines whether a vehicle speed candidate value satisfies a constraint condition (S33). When the constraint condition is satisfied (YES in S33), the speed control unit 15 determines the vehicle speed candidate value as a vehicle speed command value (S34). When the constraint condition is not satisfied (YES in S33), the speed control unit 15 determines the scheduled vehicle speed command value as a vehicle speed command value (a final command value) (S35).

The speed control unit 15 outputs the determined vehicle speed command value to at least one of the drive control device 3 and the braking control device 4 (S22B). The speed control unit 15 may output the determined vehicle speed command value to the driving plan generation unit 13. The driving plan generation unit 13 may acquire the vehicle speed command value from the speed control unit 15 and update a vehicle speed planned value of the vehicle 1 included in the driving plan information based on the vehicle speed command value.

FIG. 3C is a flowchart showing an example of the constraint condition determination processing.

The speed control unit 15 calculates a route traveling time based on the vehicle speed candidate value. The route traveling time is a time required for the vehicle 1 to travel on a route by automated driving. The route traveling time is a value obtained by adding a traveled time and a scheduled traveling time. The traveled time is a time (an actual time) obtained as a result of traveling at a predetermined speed (an actual speed, a previous speed command value) on a route (an actual route) on which a vehicle traveled to current position by automated driving. The scheduled traveling time is a time required for traveling at a speed corresponding to the vehicle speed candidate value on a route (a scheduled route) on which a vehicle is about to travel from current position by automated driving. The scheduled route may be a part of a planned route included in the driving plan information. In addition, the speed control unit 15 may calculate a route traveling time required for traveling on the entire planned route without using the actual route.

The speed control unit 15 determines whether the calculated route traveling time is equal to or less than a threshold th1 (S41). When the route traveling time is equal to or less than the threshold th1, the speed control unit 15 determines that the constraint condition is satisfied (S46). When the route traveling time is larger than the threshold th1, the speed control unit 15 proceeds to step S42.

The threshold th1 corresponds to, for example, an upper limit value of a time that is allowed as a time required for traveling on a route. For example, as the route traveling time becomes shorter, a turning curvature of the vehicle 1 becomes smaller. As the route traveling time becomes longer, the turning curvature of the vehicle 1 becomes larger. The threshold th1 may be determined in consideration of such a trade-off between a route traveling time T1 and a turning curvature of the vehicle 1.

The speed control unit 15 acquires a pulse period of a rotor of the wheel speed sensor 22 from the wheel speed sensor 22. The speed control unit 15 determines whether the pulse period of the rotor corresponding to the vehicle speed candidate value is equal to or smaller than a threshold th2 (S42). The storage unit 16 may store a pulse period of the rotor of the wheel speed sensor 22 and a vehicle speed in association with each other, and the speed control unit 15 may acquire the pulse period of the rotor corresponding to the vehicle speed candidate value from the storage unit 16. When the pulse period of the rotor is equal to or smaller than the threshold th2, it is determined that the constraint condition is satisfied (S46). When the pulse period of the rotor is larger than the threshold th2, the processing proceeds to step S43.

The threshold th2 corresponds to, for example, an upper limit value of a pulse period that is allowed by accuracy of a wheel speed measured value, and is, for example, 0.8 km/h. That is, it is determined in step S42 whether the vehicle speed candidate value is included in an extremely low speed area in which the accuracy of a vehicle speed based on the accuracy of a measured value of the wheel speed sensor 22 decreases. In this manner, the likelihood of the measured value of the wheel speed sensor 22 is taken into consideration as the constraint condition.

The speed control unit 15 determines whether the vehicle speed candidate value is equal to or larger than a threshold th3 in consideration of an idle creep (S43). When the vehicle speed candidate value is equal to or larger than the threshold th3, it is determined that the constraint condition is satisfied (S46). When the vehicle speed candidate value is smaller than the threshold th3, the processing proceeds to step S44.

The threshold th3 corresponds to, for example, a lower limit value of a vehicle speed at which it is difficult to control a vehicle speed due to the idle creep in the vehicle 1, and is, for example, 2 km/h. That is, it is determined in step S43 whether the vehicle speed candidate value is included in an extremely low speed area in which it is difficult to control a vehicle speed due to the idle creep. In this manner, ease of control of a vehicle speed, that is, ease of follow-up, are taken into consideration as the constraint condition.

The speed control unit 15 determines whether the vehicle speed candidate value is equal to or smaller than a scheduled vehicle speed command value (S44). When the vehicle speed candidate value is equal to or smaller than the scheduled vehicle speed command value, it is determined that the constraint condition is satisfied (S46). When the vehicle speed candidate value is larger than the scheduled vehicle speed command value, it is determined that the constraint condition is not satisfied (S45). When the vehicle speed candidate value is equal to or smaller than the scheduled vehicle speed command value, a turning curvature of the vehicle 1 is smaller than that in a case where the vehicle 1 automatedly travels at the scheduled vehicle speed command value, and it can be expected that parking or the like in a narrow space is easy.

In the processings of steps S41 to S44, the speed control unit 15 determines that the constraint condition is satisfied when at least one of the processings is satisfied. Alternatively, the speed control unit 15 may determine that the constraint condition is satisfied when any number or all of the processings are satisfied.

FIG. 3D is a graph showing an example of a relationship between the vehicle speed V and the turning angular velocity (normalized turning angular velocity) γ/V normalized by the speed.

A graph GI shows a relationship between V and γ/V obtained by the above-described equivalent two-wheel model. In the graph GI, γ/V decreases as V increases, and γ/V increases as V decreases. That is, a turning angle per meter increases as a vehicle speed of the vehicle 1 decreases. That is, the vehicle 1 can easily make a small turn. On the other hand, γ/V increases as V decreases, which is not necessarily optimal, and there may be various constraint conditions. For example, when the vehicle speed V decreases, a time required for the vehicle 1 to arrive at a target position (a route traveling time) may become excessively long. For example, in a low speed area, it is not ensured that a speed can be easily controlled due to an idle creep or a measurement error (measurement likelihood). An area D1 in FIG. 3D is an example of an area that satisfies the constraint condition. In the present embodiment, the driving assistance device 10 can determine a vehicle speed command value based on such a constraint condition.

<Advantages of First Embodiment>

As described above, for example, the driving assistance device 10 according to the present embodiment assists the parking of the vehicle 1 by automated driving along a route on which a driver of the vehicle 1 parks the vehicle 1 in a parking area by manual driving. The driving assistance device 10 includes the processing unit 11 that executes a processing related to the assistance of driving of the vehicle 1. The processing unit 11 acquires an input value (for example, a measured value or a planned value) of a steering angle during automated driving of the vehicle 1, and acquires a steering angle control range during automated driving of the vehicle 1. The steering angle planned value during automated driving corresponds to, for example, a steering angle measured value during manual driving. When the acquired input value of the steering angle falls outside the steering angle control range, the processing unit 11 determines a vehicle speed command value during automated driving of the vehicle 1 based on a limit value (for example, an upper limit value or a lower limit value) of the steering angle control range.

Accordingly, in a case where automated driving is performed in accordance with measured values of a steering angle or the like during manual driving, the driving assistance device 10 can control a vehicle speed to reproduce a parking trajectory during manual driving in automated driving even when a steering angle control range during manual driving is larger than a set steering angle control range during automated driving. For example, even when a driver performs steering at a steering angle of +600 degrees at the time of parking, the driving assistance device 10 can control a vehicle speed to reproduce a parking trajectory during manual driving within a steering angle control range up to +580 degrees in automated driving.

Accordingly, for example, when the vehicle 1 travels by automated driving in a narrow space such as a parking lot, the driving assistance device 10 can draw a travel trajectory equivalent to a travel trajectory drawn in accordance with a steering angle according to a driving plan, and can sequentially turn the vehicle 1 at an optimal vehicle speed at each point of the travel trajectory. In this case, the driving assistance device 10 can improve turning characteristics of the vehicle 1 by controlling a speed at an amount exceeding a steering angle control range during automated driving. Therefore, the driving assistance device 10 can improve route following performance in automated driving and reduce the number of unnecessary steering turns. As a result, for example, the driving assistance device 10 can shorten a traveling time (for example, a parking time) by automated driving in a narrow space and perform automated driving according to driving plan information.

When an input value of a steering angle falls outside a steering angle control range, the processing unit 11 may calculate a vehicle speed candidate value during automated driving of the vehicle 1 based on a limit value of the steering angle control range. When the vehicle speed candidate value satisfies a constraint condition based on the vehicle speed candidate value, the processing unit 11 may determine the vehicle speed candidate value as a vehicle speed command value.

Accordingly, when an input value of a steering angle falls outside a steering angle control range, the driving assistance device 10 temporarily derives the vehicle speed candidate value based on the limit value. Then, when the vehicle speed candidate value is less likely to cause trouble, the vehicle speed candidate value can be set as the vehicle speed command value.

In addition, the processing unit 11 may acquire a vehicle speed measured value (an actual measured value or an input value) during automated driving of the vehicle 1. The processing unit 11 may calculate a turning angular velocity during automated driving of the vehicle 1 based on the vehicle speed measured value during automated driving and a limit value of a steering angle control range during automated driving of the vehicle 1. The processing unit 11 may calculate a vehicle speed candidate value during automated driving of the vehicle 1 based on a ratio of the turning angular velocity of the vehicle 1 to the vehicle speed measured value.

Accordingly, for example, the driving assistance device 10 can derive how many times the vehicle 1 turns per meter by determining a vehicle speed during automated driving based on the ratio of the turning angular velocity of the vehicle 1 to the vehicle speed measured value. The driving assistance device 10 can use this value as an index to cause the vehicle 1 to travel at each point on a route with a turning curvature as small as possible. That is, the driving assistance device 10 can reduce the vehicle speed to be low in consideration of turning performance of the vehicle 1 at each point of a travel trajectory. Therefore, the driving assistance device 10 can turn the vehicle 1 at an optimal vehicle speed, and can further reduce the number of unnecessary steering turns during traveling in a narrow space or the like by automated driving.

The processing unit 11 may acquire driving plan information of automated driving of the vehicle 1 and acquire a route along which the vehicle 1 travels and that is included in the driving plan information. The processing unit 11 may calculate a route traveling time required for the vehicle 1 to travel on route based on a vehicle speed candidate value. When the route traveling time is equal to or less than the threshold th1, the processing unit 11 may determine that a constraint condition is satisfied.

Accordingly, the driving assistance device 10 determines whether a vehicle speed candidate value is adopted as a command value in consideration of the route traveling time. Therefore, the driving assistance device 10 can prevent the traveling time from becoming excessively long even when the vehicle 1 is sequentially turned at each point on the route at an appropriate vehicle speed during automated driving.

The processing unit 11 may acquire a pulse period of a rotor used in the wheel speed sensor 22 provided in the vehicle 1. When the pulse period of the rotor corresponding to a vehicle speed candidate value is equal to or smaller than the threshold th2, the processing unit 11 may determine that a constraint condition is satisfied.

Accordingly, the driving assistance device 10 can determine whether a vehicle speed candidate value is adopted as a command value in consideration of the pulse period of the rotor of the wheel speed sensor 22. Therefore, the driving assistance device 10 can prevent a vehicle speed command value from falling in an extremely low speed area in which the accuracy of measured values of the wheel speed sensor 22 decreases. Therefore, it is possible to prevent a decrease in accuracy of a vehicle speed measured value based on the measured values of the wheel speed sensor 22, and it is possible to improve route following performance in accordance with the vehicle speed command value.

When a vehicle speed candidate value is larger than the threshold th3 corresponding to an upper limit value of a vehicle speed at which an idle creep occurs in the vehicle 1, the processing unit 11 may determine that a constraint condition is satisfied.

Accordingly, the driving assistance device 10 can determine whether a vehicle speed candidate value is adopted as a command value in consideration of the idle creep of the vehicle 1. Therefore, it is possible to prevent a speed control in accordance with a steering angle from being executed in a state in which the accuracy of a vehicle speed is unstable due to the idle creep.

The processing unit 11 may acquire driving plan information of automated driving of the vehicle 1. The processing unit 11 may acquire host vehicle position information that is information indicating a vehicle position during automated driving of the vehicle 1. The processing unit 11 may calculate a scheduled vehicle speed command value based on the driving plan information and the host vehicle position information. When the vehicle speed candidate value during automated driving of the vehicle 1 is smaller than the calculated scheduled command value, the processing unit 11 may determine that a constraint condition is satisfied.

Accordingly, the driving assistance device 10 can set a vehicle speed command value to be smaller than a scheduled command value derived based on the driving plan information, and can cause the vehicle 1 to travel at a turning curvature smaller than a turning curvature assumed in a vehicle driving plan. That is, for example, the driving assistance device 10 can further reduce the number of steering turns in automated driving by appropriately setting a turning angle in a narrow space such as a parking lot.

The processing unit 11 may acquire driving plan information of automated driving of the vehicle 1. An input value of a steering angle may be a vehicle steering angle planned value included in the driving plan information.

Accordingly, the driving assistance device 10 can derive a vehicle speed command value based on the steering angle planned value according to the driving plan information of automated driving. Therefore, the driving assistance device 10 can determine a vehicle speed command value at each point of a travel trajectory of the vehicle 1 even when a simulation of a speed control is performed according to a driving plan or the like, instead of at a timing when the vehicle 1 is actually parked by automated driving.

The processing unit 11 may acquire a vehicle speed measured value during automated driving of the vehicle 1. An input value of a steering angle may be a steering angle measured value of the vehicle 1.

Accordingly, the driving assistance device 10 can determine a vehicle speed command value at each point of a travel trajectory when the vehicle 1 is actually parked by automated driving.

The processing unit 11 may acquire a traveling state measured value of the vehicle 1 during manual driving (for example, a measured value measured by each sensor included in the sensor group 20). The processing unit 11 may generate driving plan information during automated driving of the vehicle 1 based on the traveling state measured value of the vehicle 1 during manual driving.

Accordingly, the driving assistance device 10 can measure the driving state of the vehicle 1 using the traveling state measured value of the vehicle 1 during manual driving measured using each sensor, and can reflect the measured value in driving plan information during automated driving as a previous driving actual result. Therefore, the driving assistance device 10 can reproduce driving achieved in the past by performing automated driving in accordance with the driving plan information. In this case, when a steering angle during automated driving exceeds a control range, it is possible to bring a travel trajectory close to a travel trajectory that is the same as that during manual driving by controlling a speed.

### Second Embodiment

Next, a second embodiment will be described.

Components the same or similar to those of the first embodiment will be denoted by the same or similar reference numerals, and thus description thereof may be omitted or simplified.

<Configuration of Driving Assistance Device>

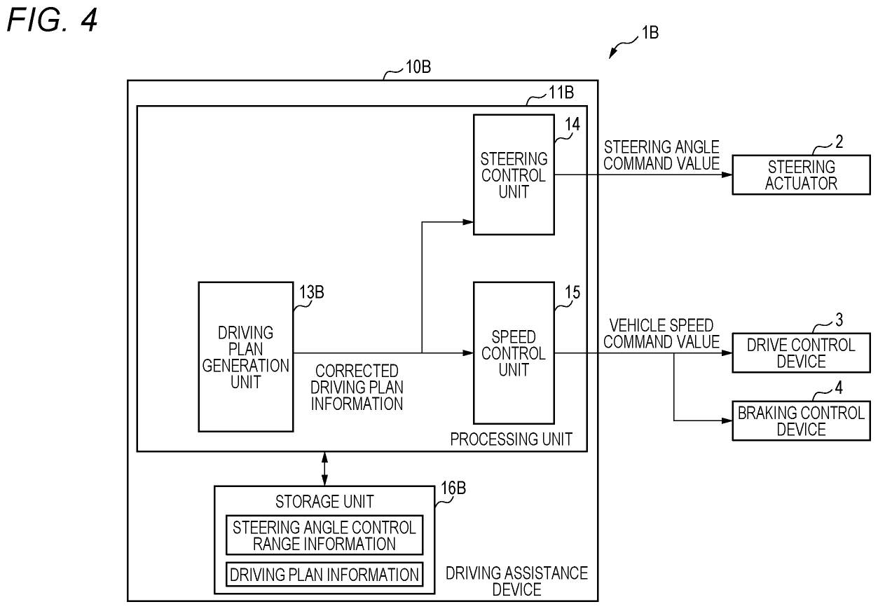

A control configuration of a vehicle 1B including a driving assistance device 10B according to the present embodiment will be described with reference to FIG. 4. FIG. 4 is a block diagram showing a control configuration of the vehicle 1B according to the present embodiment.

In the first embodiment, a steering angle acquired by the steering control unit 14 is a steering angle measured value (an actual measured value) of the vehicle 1B, and a vehicle speed command value is determined with reference to the measured value when the vehicle 1B travels by automated driving. That is, vehicle speeds are sequentially determined in parallel with traveling during traveling of the vehicle 1B during automated driving in the first embodiment. In the present embodiment, vehicle speeds are not sequentially determined and updated while the vehicle 1B actually travels in automated driving, and a vehicle speed planned value is updated (corrected) at a planning stage of automated driving.

As shown in FIG. 4, the driving assistance device 10B includes a processing unit 11B and a storage unit 16B in the present embodiment. The processing unit 11B includes a driving plan generation unit 13B, the steering control unit 14, and the speed control unit 15. The processing unit 11B may include the host vehicle position estimation unit 12.

The storage unit 16B stores driving plan information. The storage unit 16B transmits, to the driving plan generation unit 13B, a steering angle planned value and a vehicle speed planned value that are used for traveling in a narrow space such as a parking lot by automated driving and are included in driving plan information. The storage unit 16B stores information about a steering angle control range during automated driving. After the driving plan information is corrected, the storage unit 16B stores the corrected driving plan information.

Based on a steering angle command value and a vehicle speed command value of the vehicle 1B that are derived in the first embodiment, the driving plan generation unit 13B updates the vehicle speed planned value included in the driving plan information in advance before automated driving is performed. In this case, the vehicle speed planned value may be updated each time a vehicle speed command value at each position on a planned route is derived, or a vehicle speed planned value corresponding to each position may be collectively updated after a vehicle speed command value at each position on the planned route is derived.

That is, the driving plan generation unit 13B acquires the driving plan information including the steering angle planned value and the vehicle speed planned value and a steering angle control range from the storage unit 16B. The driving plan generation unit 13B determines whether the steering angle planned value at each point of a travel trajectory in a plan falls outside the steering angle control range for the entire driving plan information. As a result of the determination, when it is determined that a steering angle calculated value falls outside the control range, the driving plan generation unit 13B optimizes a vehicle speed command value corresponding to the steering angle that is determined to fall outside the control range, and updates a vehicle speed planned value. A method for optimizing a vehicle speed command value may be the same as that in the first embodiment.

The driving plan generation unit 13B transmits driving plan information (corrected driving plan information) including the updated steering angle planned value and the updated vehicle speed planned value to the steering control unit 14 and the speed control unit 15.

The steering control unit 14 calculates a steering angle command value based on the steering angle planned value and the vehicle speed planned value that are transmitted from the driving plan generation unit 13B, and transmits the steering angle command value to the steering actuator 2.

Similarly, the speed control unit 15 calculates a vehicle speed command value based on the steering angle planned value and the vehicle speed planned value that are transmitted from the driving plan generation unit 13B, and transmits the vehicle speed command value to the drive control device 3 and the braking control device 4. At this time, the steering control unit 14 and the speed control unit 15 synchronously transmit the steering angle command value and the vehicle speed command value at each point of an actual travel trajectory.

Here, in the present embodiment, before the vehicle 1B actually travels by automated driving, the vehicle speed planned value is updated (corrected) and determined based on a steering angle calculated value of the vehicle 1B included in the driving plan information. Therefore, different from the first embodiment, the steering control unit 14 may not transmit the vehicle speed command value to the speed control unit 15.

<Processing Flow of Driving Plan Generation Unit>

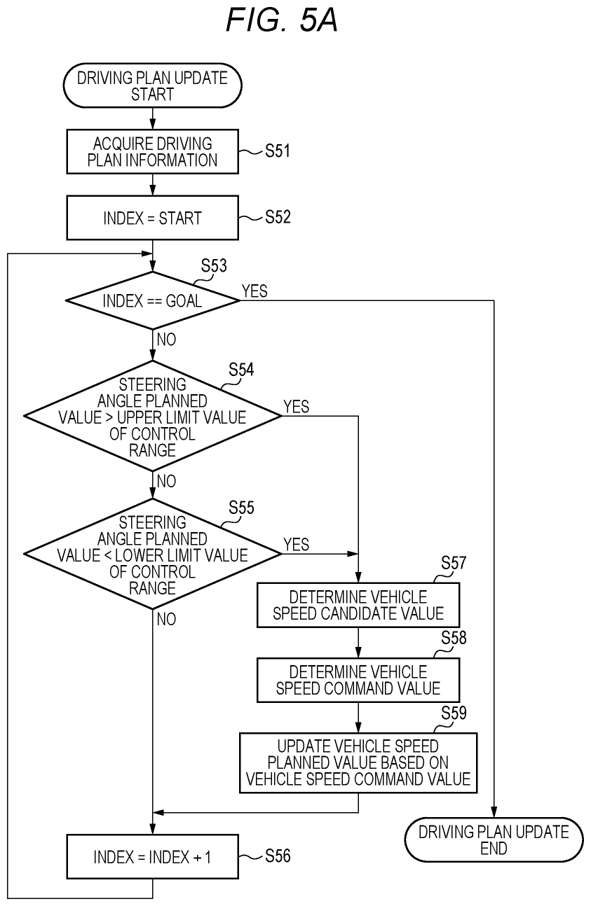

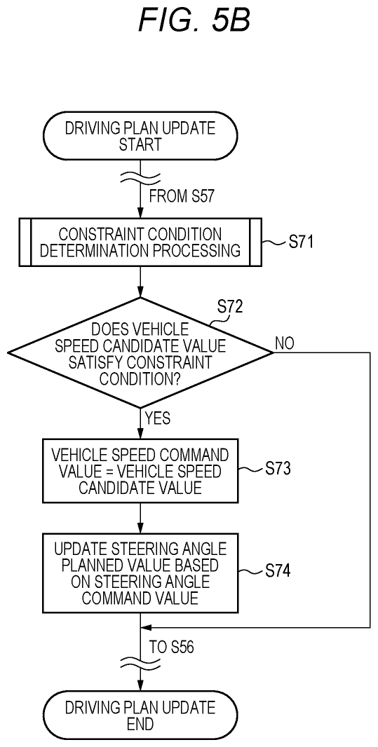

A processing flow of the driving plan generation unit 13B will be described with reference to FIG. 5A. FIG. 5A is a flowchart showing a first operation example of the driving plan generation unit 13B.

The driving plan generation unit 13B sets and stores a variable Index that is a counter variable. The variable Index is a natural number, and refers to each point from a travel start point (a variable start) to a travel end point (a variable goal) of a planned travel trajectory in the driving plan information. Each variable Index is associated with a steering angle planned value and a vehicle speed planned value at each point.

The driving plan generation unit 13B acquires driving plan information for automated driving of the vehicle 1B which is stored in the storage unit 16B (S51). The driving plan information includes a steering angle planned value and a vehicle speed planned value of the vehicle 1B. The steering angle planned value is associated with the variable Index and the vehicle speed planned value.

The driving plan generation unit 13B sets a variable “start” of the variable “Index” as an input value, and sequentially executes the subsequent processings (steps) from the travel start point of the travel trajectory (S52). The driving plan generation unit 13B determines whether the variable Index matches the variable goal (S53). As a result of the determination, when it is determined that the variable Index matches the variable goal (YES in S53), that is, when the processing is completed for all points of the travel trajectory up to the travel end point, the driving plan generation unit 13B ends the processing (END).

On the other hand, when it is determined that the variable Index does not match the variable goal (NO in S53), the driving plan generation unit 13B reads a steering angle planned value and a vehicle speed planned value corresponding to the variable Index of the driving plan information.

The driving plan generation unit 13B determines whether the steering angle planned value is larger than an upper limit value of a steering angle control range (S54). As a result of the determination, when it is determined that the steering angle planned value is equal to or smaller than the upper limit value (NO in S54), the driving plan generation unit 13B determines whether the steering angle planned value is smaller than a lower limit value of the steering angle control range (S55). That is, in steps S54 and S55, the driving plan generation unit 13B comprehensively determines whether the steering angle planned value falls outside or within the control range in automated driving.

When the driving plan generation unit 13B determines that the steering angle planned value falls within the steering angle control range (NO in S54 and NO in S55), the driving plan generation unit 13B updates the variable Index by adding 1 that is a natural number to the variable Index (S56), and returns the processing to step S53 after the update. By returning the processing flow to step S53, the driving plan generation unit 13B can sequentially execute the processings from step S53 to step S59 again for a steering angle planned value and a vehicle speed planned value at a subsequent point on the travel trajectory.

When it is determined that the steering angle planned value falls outside the control range (YES in S54 or YES in S55), the driving plan generation unit 13B calculates a vehicle speed candidate value based on the steering angle planned value and the upper limit value or the lower limit value of the control range (S57). The vehicle speed candidate value is calculated in the same manner as that in the first embodiment. Instead of a steering angle measured value and a vehicle speed measured value, a steering angle planned value and a vehicle speed planned value are used. For example, when the yaw motion model used in the processing of calculating the vehicle speed candidate value is an equivalent two-wheel model, δ in the Equation (1) is a steering angle planned value, and V is a vehicle speed planned value.

The driving plan generation unit 13B determines the calculated vehicle speed candidate value as a vehicle speed command value (S58). The driving plan generation unit 13B updates the vehicle speed planned value included in the driving plan information based on the determined vehicle speed command value (S59). Then, the driving plan generation unit 13B updates the variable Index by adding 1 that is a natural number to the variable Index as described above (S56), and returns the processing to step S53 after the update.

Next, FIG. 5B is a flowchart showing a second operation example of the driving plan generation unit 13B. In FIG. 5B, description of processings (steps) the same as those in FIG. 5A will be omitted or simplified.

In FIG. 5B, after the vehicle speed candidate value is calculated in step S57, the driving plan generation unit 13B executes a constraint condition determination processing (S71). The constraint condition determination processing in step S71 may be the same as that in the first embodiment (see FIG. 3C), and thus description thereof will be simplified. In the second embodiment, since the vehicle 1B is not actually automatedly driven, there is no scheduled vehicle speed command value. Therefore, a steering angle planned value is used instead of a steering angle measured value, and a vehicle speed planned value is used instead of a vehicle speed measured value.

After the constraint condition determination processing, the driving plan generation unit 13B determines whether the vehicle speed candidate value satisfies the constraint condition (S72). When the constraint condition is satisfied (YES in S72), the speed control unit 15 determines the vehicle speed candidate value as a vehicle speed command value (S73). The driving plan generation unit 13B updates the vehicle speed planned value included in the driving plan information based on the determined vehicle speed command value (S74). After the processing of step S74, the processing proceeds to step S56 in FIG. 5A.

When the constraint condition is not satisfied (NO in S72), the speed control unit 15 does not set the vehicle speed candidate value as a vehicle speed command value (not shown). Therefore, the driving plan generation unit 13B does not update the vehicle speed planned value included in the driving plan information.

<Advantages of Second Embodiment>

As described above, the driving assistance device 10B according to the present embodiment includes the processing unit 11B that executes a processing related to the assistance of driving of the vehicle 1B. The processing unit 11B acquires a steering angle planned value (an example of an input value) during automated driving of the vehicle 1B, and acquires a steering angle control range during automated driving of the vehicle 1B. When the acquired steering angle planned value falls outside the steering angle control range, the processing unit 11 determines a vehicle speed command value during automated driving of the vehicle 1B based on a limit value (for example, an upper limit value or a lower limit value) of the steering angle control range. The driving assistance device 10B includes the storage unit 16B that stores driving plan information of automated driving of the vehicle 1B. The processing unit 11B updates a vehicle speed planned value of the vehicle 1B included in the driving plan information based on the vehicle speed command value during automated driving of the vehicle 1B.

Accordingly, during automated driving, the driving assistance device 10B can draw a travel trajectory equivalent to a travel trajectory drawn in accordance with a steering angle according to a driving plan, and can update a vehicle speed planned value such that the vehicle 1B is sequentially turned at an optimal vehicle speed at each point of the travel trajectory. As a result, for example, the driving assistance device 10B can shorten a traveling time (for example, a parking time) in a narrow space by automated driving and perform automated driving according to the updated driving plan information. Therefore, when automated driving is actually performed, the driving assistance device 10B can improve route following performance and reduce the number of unnecessary steering turns.

Other functions and effects are the same as those of the first embodiment.

### Third Embodiment

Next, a third embodiment will be described.

Components the same or similar to those of the first embodiment or the second embodiment will be denoted by the same or similar reference numerals, and thus description thereof may be omitted or simplified.

<Configuration of Driving Assistance Device>

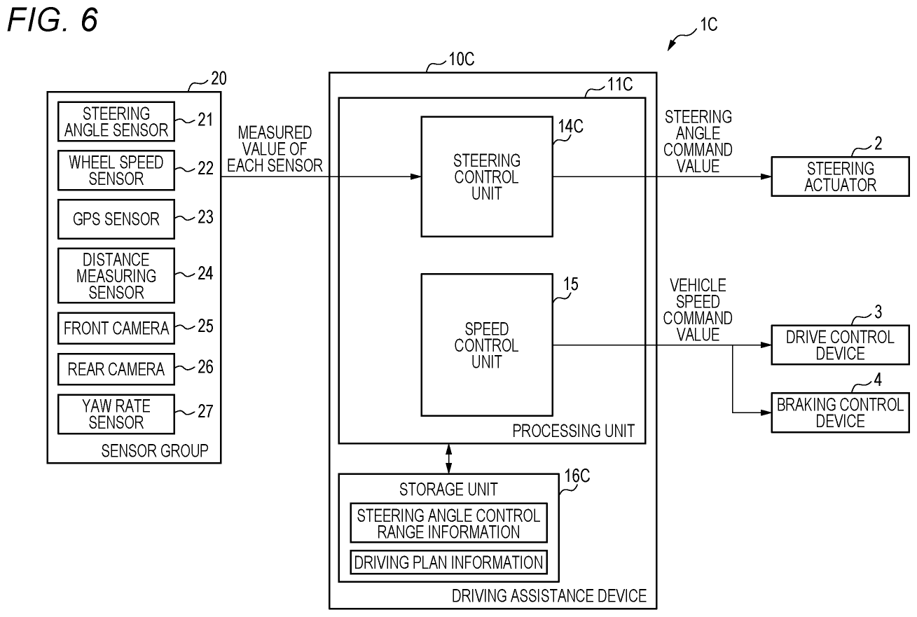

A control configuration of a vehicle 1C including a driving assistance device 10C according to the present embodiment will be described with reference to FIG. 6. FIG. 6 is a block diagram showing a control configuration of the vehicle 1C according to the present embodiment.

In the first embodiment or the second embodiment, when a steering angle input value (for example, a measured value or a planned value) acquired during automated driving falls outside the steering angle control range, a vehicle speed is updated and determined in a state in which the steering angle control range is maintained without being changed. On the other hand, in the present embodiment (including a fourth embodiment to be described later), the steering angle control range during automated driving is changed.

As shown in FIG. 6, the driving assistance device 10C includes a processing unit 11C and a storage unit 16C in the present embodiment. The processing unit 11C includes a steering control unit 14C and the speed control unit 15. The processing unit 11C may include the host vehicle position estimation unit 12 and the driving plan generation unit 13.

The steering control unit 14C acquires a steering angle measured value measured during manual driving of the vehicle 1C. The steering control unit 14C acquires a steering angle control range during automated driving of the vehicle 1C from the storage unit 16C. The steering control unit 14C compares the acquired steering angle measured value with the steering angle control range. As a result of the comparison, when the steering angle measured value falls outside the steering angle control range, the steering control unit 14C changes an upper limit value or a lower limit value of the steering angle control range to the steering angle measured value of the vehicle 1C and updates the steering angle control range. That is, the steering angle control range is updated to immediately follow an actual operation state of a steering angle (a control range during manual driving), and is stored in the storage unit 16C.

The steering control unit 14C sets a driving mode of the vehicle 1C. The setting information of the driving mode is stored in the storage unit 16C. The driving mode includes a manual driving mode and an automated driving mode. The manual driving mode is a driving mode for the vehicle 1C to perform manual driving. The manual driving mode includes a sequential update mode and a learning mode. The sequential update mode is a driving mode in which steering angle control ranges are sequentially updated during manual driving when a steering angle during manual driving exceeds a steering angle control range during automated driving, that is, when a steering angle measured value falls outside the steering angle control range. The learning mode is a driving mode for generating driving plan information of automated driving based on manual driving. The manual driving mode may not be specially prepared, and the automated driving mode, the sequential update mode, and the learning mode may be prepared. The setting of the driving mode may be performed based on, for example, an operation input to an operation unit (not shown).

In the present embodiment, the updated steering angle control range during automated driving is expanded compared to the steering angle control range before the update, and a difference (a margin) between the updated steering angle control range and a steering angle control range during manual driving is reduced. For example, a control range of −580° to +5800 is set as a control range of −590° to +590°. As a result of this expansion, the steering angle control range during automated driving is reset to be close to the steering angle control range during manual driving, and is updated to a range that matches individual characteristics of the vehicle 1C. When the vehicle 1C travels by automated driving after manual driving, the vehicle 1C is steered in accordance with a steering control range that matches individual characteristics of the vehicle 1C.

<Processing Flow of Steering Control Unit>

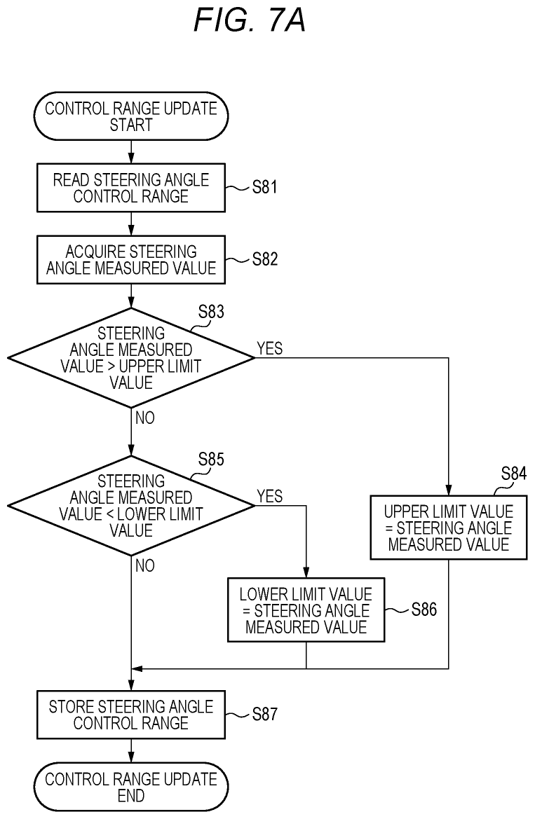

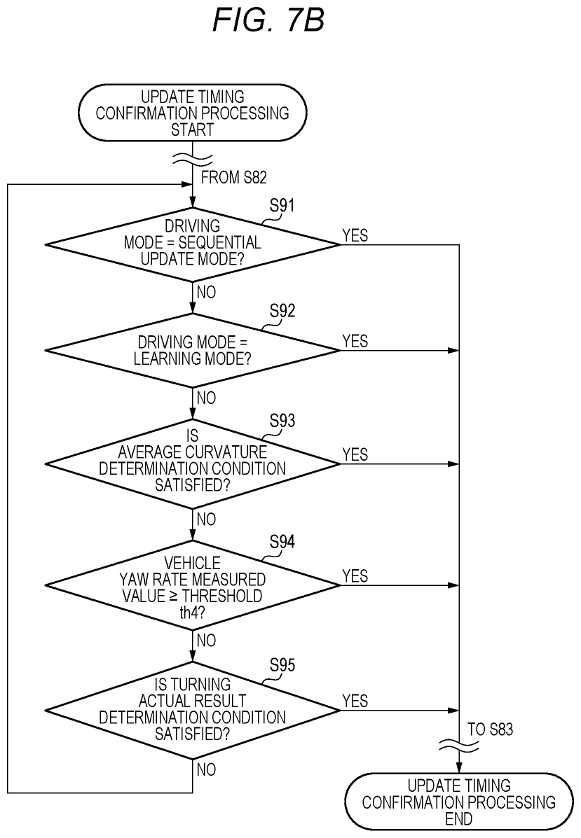

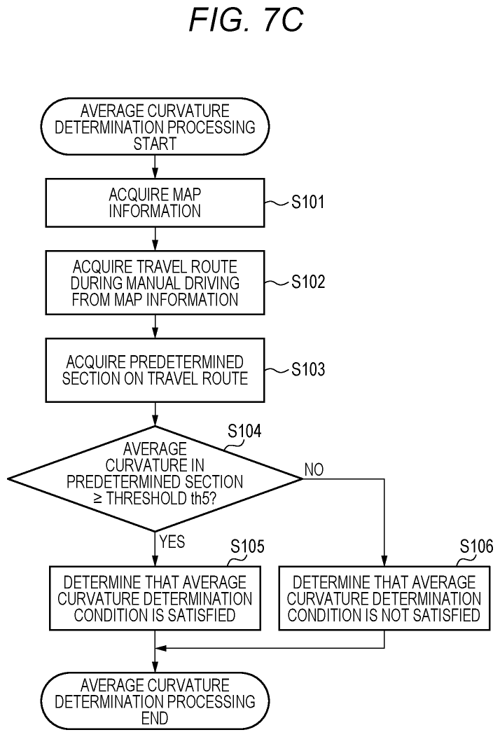

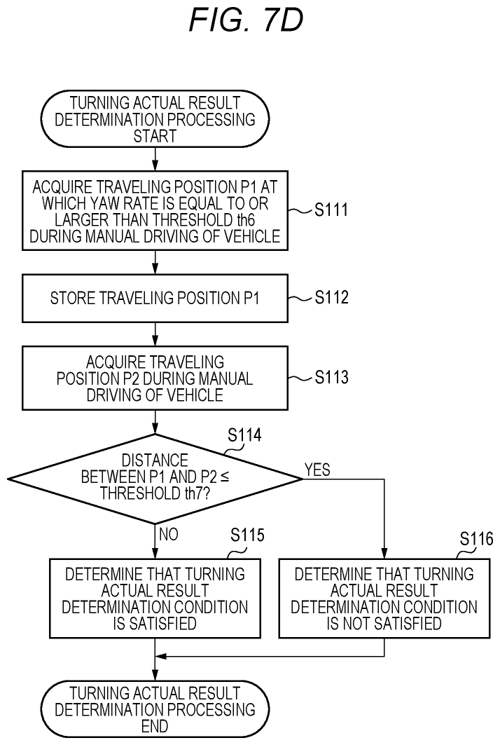

A processing flow of the steering control unit 14C will be described with reference to FIG. 7A. FIG. 7A is a flowchart showing a first example of a processing executed by the steering control unit 14C. The steering control unit 14C sequentially executes the processings shown in FIG. 7A when the vehicle 1C actually travels by manual driving. The manual driving can be determined based on the fact that a driving mode is set to a manual driving mode, the fact that a driving mode is not set to an automated driving mode, or the like.

When the steering control unit 14C determines that traveling by manual driving is started, the steering control unit 14C starts the processing flow shown in FIG. 7A (START). As shown in FIG. 7A, the steering control unit 14C reads the steering angle control range during automated driving stored in the storage unit 16C (S81). Next, the steering control unit 14C acquires a steering angle measured value measured by the steering angle sensor 21 during manual driving of the vehicle 1C (S82).

The steering control unit 14C determines whether the steering angle measured value during manual driving is larger than an upper limit value of the steering angle control range during automated driving (S83). As a result of the determination, when it is determined that the steering angle measured value during manual driving is equal to or smaller than the upper limit value of the steering angle control range during automated driving (NO in S83), the steering control unit 14C determines whether the steering angle measured value during manual driving is smaller than a lower limit value of the steering angle control range during automated driving (S85). That is, in step S83 and step S85, the steering control unit 14C determines whether the steering angle measured value measured during manual driving of the vehicle 1C falls outside or within the steering angle control range used in automated driving. When it is determined that the steering angle measured value during manual driving falls within the steering angle control range during automated driving (NO in S83 and NO in S85), the steering control unit 14C stores the steering angle control range during automated driving in the storage unit 16C without updating the steering angle control range during automated driving (S87).

On the other hand, when the steering control unit 14C determines that the steering angle measured value during manual driving is larger than the upper limit value of the steering angle control range during automated driving (YES in S83), the steering control unit 14C updates (overwrites) the upper limit value of the steering angle control range during automated driving to the steering angle measured value during manual driving (S84). Similarly, when the steering control unit 14C determines that the steering angle measured value during manual driving is smaller than the lower limit value of the control range during automated driving (YES in S85), the steering control unit 14C updates the lower limit value of the steering angle control range during automated driving to the steering angle measured value (S86). Then, the steering control unit 14C stores information about the updated steering angle control range during automated driving in the storage unit 16C (S87).

Next, FIG. 7B is a flowchart showing a second example of a processing executed by the steering control unit 14C. In FIG. 7B, description of processings (steps) the same as those in FIG. 7A will be omitted or simplified. FIG. 7B is different from FIG. 7A in that the steering control unit 14C executes an update timing confirmation processing between step S82 and step S83 in FIG. 7A.

In the update timing confirmation processing of FIG. 7B, the steering control unit 14C determines whether a driving mode is set to the sequential update mode (S91). When the driving mode is set to the sequential update mode, the processing proceeds to a comparison processing of comparing a steering angle measured value during manual driving with the steering angle control range during automated driving in step S83 and subsequent steps in FIG. 7A. When the driving mode is not set to the sequential update mode, the processing proceeds to step S92.

The steering control unit 14C determines whether the driving mode is set to the learning mode (S92). When the driving mode is set to the learning mode, the processing proceeds to the comparison processing after step S83 in FIG. 7A. When the driving mode is not set to the learning mode, the processing proceeds to step S93.

The steering control unit 14C determines whether an average curvature determination condition is satisfied (S93). When the average curvature determination condition is satisfied, the processing proceeds to the comparison processing after step S83 in FIG. 7A. When the average curvature determination condition is not satisfied, the processing proceeds to step S94. Details of an average curvature determination processing for determining whether the average curvature determination condition is satisfied will be described later.

The steering control unit 14C acquires a turning angular velocity measured value during manual driving of the vehicle 1C. The measured value may be a measured value measured by a yaw rate sensor 27 included in the sensor group 20. The steering control unit 14C determines whether the acquired turning angular velocity measured value is equal to or larger than a threshold th4 (S94). The threshold th4 may be any value, and may correspond to, for example, a lower limit value of a value at which it is estimated that a steering wheel is suddenly turned. When the acquired turning angular velocity measured value is equal to or larger than the threshold th4, the processing proceeds to the comparison processing after step S83 in FIG. 7A. When the acquired turning angular velocity measured value is smaller than the threshold th4, the processing proceeds to step S95.

The steering control unit 14C determines whether a turning actual result determination condition is satisfied (S95). When the turning actual result determination condition is satisfied, the processing proceeds to the comparison processing after step S83 in FIG. 7A. When the turning actual result determination condition is not satisfied, the steering control unit 14C determines that it is not an update timing of the steering angle control range during automated driving, and proceeds to step S91. Details of the turning actual result determination condition for determining whether the turning actual result determination condition is satisfied will be described later.

A case of considering the sequential update mode will be supplemented. When the sequential update mode is set, the steering control unit 14C uniformly updates the steering angle control range when it is determined that the vehicle 1C is in manual driving. In this case, the steering control unit 14C sequentially acquires steering angle measured values sequentially measured by the steering angle sensor 21 during manual driving of the vehicle 1C. When the steering control unit 14C determines that the acquired steering angle measured value falls outside the steering angle control range during automated driving, the steering control unit 14C expands the steering angle control range stored in the storage unit 16C described above and updates the steering angle control range, that is, updates (overwrites) the control range according to an actual state. Accordingly, the driving assistance device 10C can frequently update the steering angle control range during automated driving. Therefore, driving characteristics during manual driving can be easily reflected in the steering angle control range without missing an opportunity.

A case of considering the learning mode will be supplemented. In the learning mode, since a driving plan of automated driving is generated based on manual driving, it is expected that a result of learning manual driving in the learning mode is utilized in automated driving performed after the learning. Therefore, in a case where the learning mode is set, the driving assistance device 10C changes the steering angle control range during automated driving according to a result of the comparison processing, and thus it is possible to reproduce driving characteristics of manual driving in automated driving even when steering is performed in a wide range of steering angles.

A case of considering a turning angular velocity measured value during manual driving will be supplemented. At a turning angular velocity (yaw rate), it is possible to determine at what degree of curvature the vehicle 1C turns. Therefore, by considering a turning angular velocity measured value during manual driving, the driving assistance device 10C can determine the necessity of updating the steering angle control range during automated driving only in a case where the vehicle makes a large turn that is equal to or larger than a reference turn, that is, only in a case where a steering angle is increased.

Next, the average curvature determination processing will be described in detail. FIG. 7C is a flowchart showing an example of the average curvature determination processing.

The steering control unit 14C acquires map information during manual driving (S101). The map information can be used by, for example, a car navigation device, and includes information about a road (a route) on which the vehicle 1C can travel. The steering control unit 14C may acquire the map information from the storage unit 16C. Alternatively, for example, the steering control unit 14C may communicate with an external server via a wireless communication unit provided in the vehicle and receive the map information from the external server.

The steering control unit 14C acquires a travel route during manual driving from the map information (S102). The steering control unit 14C may acquire a travel route by acquiring operation information via, for example, an operation unit (for example, a touch panel of a car navigation device) and designating the travel route based on the operation information.

The steering control unit 14C acquires a predetermined section on the travel route (S103). The steering control unit 14C may acquire the predetermined section by, for example, acquiring operation information via the operation unit and designating the predetermined section based on the operation information.

The steering control unit 14C determines whether an average curvature in the predetermined section of the travel route is equal to or larger than a threshold th5 (S104). When the average curvature is equal to or larger than the threshold th5, the steering control unit 14C determines that the average curvature determination condition is satisfied (S105). When the average curvature is smaller than the threshold th5, the steering control unit 14C determines that the average curvature determination condition is not satisfied (S106). The threshold th5 is any value, and is, for example, a value corresponding to a lower limit value of a curvature at which it is recognized that a road is sharply curved or a road is twisted.

That is, for example, in a case where a driver of the vehicle 1C sets a travel route of manual driving using a car navigation device, when it is known that at least a part of the travel route on the map is a route with many sharp curves before traveling is performed by manual driving, the steering angle control range during automated driving is set to an updatable state. As a result, when the vehicle 1C actually travels by manual driving and approaches a point of a sharp curve, a steering angle measured value during manual driving increases, and thus a steering angle falls outside the steering angle control range during automated driving, and the steering angle control range is updated. Therefore, the driving assistance device 10C can travel through a point corresponding to a sharp curve on the map by controlling the steering angle even during automated driving.

Alternatively, an average curvature of the entire travel route during manual driving may be compared with the threshold th5 instead of considering the predetermined section on the travel route.

Next, the turning actual result determination processing will be described in detail.

FIG. 7D is a flowchart showing an example of the turning actual result determination processing.

A turning actual result of the vehicle 1C is obtained at the time of first manual driving and is used at the time of second manual driving. That is, two timings are assumed here. In a first scene, a traveling state during manual driving is detected as an actual result by the sensor group 20 at a first timing. In a second scene, the steering angle control range can be updated at a second timing when the vehicle comes close to a specific place where the vehicle traveled by manual driving at the first timing.

The steering control unit 14C acquires a turning angular velocity during manual driving of the vehicle 1C from the yaw rate sensor 27. The steering control unit 14C acquires a host vehicle position (a traveling position) during manual driving of the vehicle 1C from, for example, the GPS sensor 23. Based on the turning angular velocity and the host vehicle position, the steering control unit 14C acquires a traveling position P1 of the vehicle 1C at which the turning angular velocity during manual driving of the vehicle 1C is equal to or larger than a threshold th6 (S111). The steering control unit 14C stores the acquired traveling position P1 in the storage unit 16C (S112).

The steering control unit 14C acquires a host vehicle position during manual driving of the vehicle 1C as a traveling position P2 from, for example, the GPS sensor 23 at a timing different from the time points in steps S111 and S112, for example, in manual driving on a day different from the time points of steps S111 and S112 (S113). The steering control unit 14C determines whether a distance between the traveling position P1 and the traveling position P2 is equal to or smaller than a threshold th7 (S114). When the distance is equal to or smaller than the threshold th7, the steering control unit 14C determines that the turning actual result determination condition is satisfied (S115). When the distance is larger than the threshold th7, the steering control unit 14C determines that the turning actual result determination condition is not satisfied (S116).

That is, the driving assistance device 10C stores, as the traveling position P1, a point where a sharp curve is present as a steering actual result by manual driving and manual driving with a large steering angle is performed. When the vehicle comes close to the traveling position P1 during manual driving at another timing, the steering angle control range during automated driving is set to an updatable state. As a result, when the vehicle 1C continues to travel by manual driving and comes close to a point of a sharp curve, a steering angle measured value increases, and the measured value falls outside the steering angle control range during automated driving, and the steering angle control range is updated. Therefore, the driving assistance device 10C can travel through the point corresponding to the sharp curve that is a steering actual result by controlling the steering angle even during automated driving. For example, when the vehicle 1C comes close to a parking lot where the vehicle 1C is frequently parked, the driving assistance device 10C enables a function of expanding a control range in the vicinity of the parking lot.

<Advantages of Third Embodiment>

As described above, the driving assistance device 10C according to the present embodiment includes the processing unit 11C that executes a processing related to the assistance of driving of the vehicle 1C. The processing unit 11C includes the steering control unit 14C. The processing unit 11C acquires a steering angle measured value measured during manual driving of the vehicle 1C, and acquires a steering angle control range during automated driving of the vehicle 1C. The processing unit 11C compares the steering angle measured value during manual driving with the steering angle control range during automated driving. When the steering angle measured value during manual driving is not included in the steering angle control range during automated driving, the processing unit 11C updates the steering angle control range during automated driving so as to include the steering angle measured value during manual driving. In this case, a limit value (for example, an upper limit value or a lower limit value) of the steering angle control range during automated driving may be updated to the steering angle measured value during manual driving. In this case, the upper limit value of the steering angle control range during automated driving may be updated to the steering angle measured value during manual driving.

In a case where there is a driving actual result of manual driving, even when the steering angle control range is expanded up to a steering angle of the driving actual result, the steering angle control range can be realized in the vehicle 1C. In automated driving, an initial value of the steering angle control range is set to be narrow in consideration of individual variations of the vehicle 1C. In contrast, the driving assistance device 10C can cause the vehicle 1C to travel in a steering angle control range that matches individual characteristics of the vehicle 1C in automated driving by changing the steering angle control range during automated driving based on a steering angle measured value (an actual measured value) during manual driving. Accordingly, the driving assistance device 10C can improve route following performance in a narrow space such as a parking lot by automated driving or traveling on a sharp curve, and can reduce the number of unnecessary steering turns. As a result, a traveling time of automated driving in a narrow space can be shortened, and automated driving according to driving plan information can be performed.

Accordingly, in a case where automated driving is performed in accordance with measured values of a steering angle or the like during manual driving, the driving assistance device 10C can reproduce a parking trajectory during manual driving in automated driving since a steering angle control range during manual driving is equal to a set steering angle control range during automated driving.

When the steering angle measured value during manual driving of the vehicle 1C falls outside the steering angle control range during automated driving, the processing unit 11C may change a limit value of the steering angle control range during automated driving to the steering angle measured value of the vehicle 1C to expand the steering angle control range.

Accordingly, the driving assistance device 10C can expand the steering angle control range by changing the upper limit value or the lower limit value of the steering angle control range during automated driving to the steering angle measured value during manual driving of the vehicle 1C. Therefore, for example, in a case where automated driving is performed according to a driving plan based on manual driving, the driving assistance device 10C can accurately reproduce manual driving in automated driving even when a steering angle during manual driving is larger than the steering angle control range during automated driving.

The processing unit 11C may sequentially acquire steering angle measured values that are sequentially measured during manual driving of the vehicle 1C. The processing unit 11C may sequentially compare the steering angle measured values during manual driving with the steering angle control range during automated driving.

Accordingly, the driving assistance device 10C can constantly set the steering angle control range during automated driving to an updatable state. Therefore, the driving assistance device 10C can frequently update the steering angle control range during automated driving. Therefore, the driving assistance device 10C can quickly reflect driving characteristics during manual driving in the steering angle control range.

The processing unit 11C may set the driving mode of the vehicle 1C. When the driving mode of the vehicle 1C is set to the learning mode for generating a driving plan of automated driving based on manual driving of the vehicle 1C, the steering angle measured value during manual driving may be compared with the steering angle control range during automated driving.

Accordingly, the driving assistance device 10C can set the steering angle control range during automated driving to an updatable state at a timing at which a driver intends to utilize driving characteristics of manual driving as driving characteristics of automated driving.

The processing unit 11C may acquire map information, acquire a route along which a vehicle travels by manual driving from the map information, and compare the steering angle measured value during manual driving with the steering angle control range during automated driving when an average curvature of a predetermined section on the route is equal to or larger than the threshold th5.

Accordingly, in a case where it is assumed that a steering angle during manual driving becomes extremely large on the route on the map, the driving assistance device 10C can set the steering angle control range during automated driving to an updatable state.

The processing unit 11C may acquire a turning angular velocity during manual driving of the vehicle. When the turning angular velocity is equal to or larger than the threshold th4, the processing unit 11C may compare the steering angle measured value during manual driving with the steering angle control range during automated driving.

Accordingly, when the vehicle 1C actually makes a large turn during manual driving, the driving assistance device 10C can set the steering angle control range during automated driving to an updatable state. In such a case, for example, it is expected that a traveling position of the vehicle 1C is at a sharp curve or the like. The driving assistance device 10C can update the steering angle control range during automated driving based on a steering angle measured value at the sharp curve.

The driving assistance device 10C may include the storage unit 16C. During manual driving of the vehicle 1C, the processing unit 11C may acquire the traveling position P1 (an example of a first traveling position) at which a turning angular velocity of the vehicle 1C that is equal to or larger than the threshold th6 is measured. The processing unit 11C may store the traveling position P1 in the storage unit 16C. During manual driving of the vehicle 1C, the processing unit 11C may acquire the traveling position P2 (an example of a second traveling position) at which the vehicle travels. When a distance between the traveling position P1 and the traveling position P2 is smaller than the threshold th7, the processing unit 11C may compare the steering angle measured value during automated driving with the steering angle control range during automated driving.

As a result, the driving assistance device 10C stores, for example, a steering actual result at a sharp curve and a position of the sharp curve in the storage unit 16C, and can set the steering angle control range during automated driving to an updatable state when the vehicle comes close to the same position at a subsequent timing. Therefore, when the vehicle 1C comes close to the position of the same sharp curve again, the steering angle control range can be expanded based on the steering angle measured value.

### Fourth Embodiment

Next, a fourth embodiment will be described.

Components the same or similar to those of the first embodiment, the second embodiment, or the third embodiment will be denoted by the same or similar reference numerals, and thus description thereof may be omitted or simplified.

<Configuration of Driving Assistance Device>

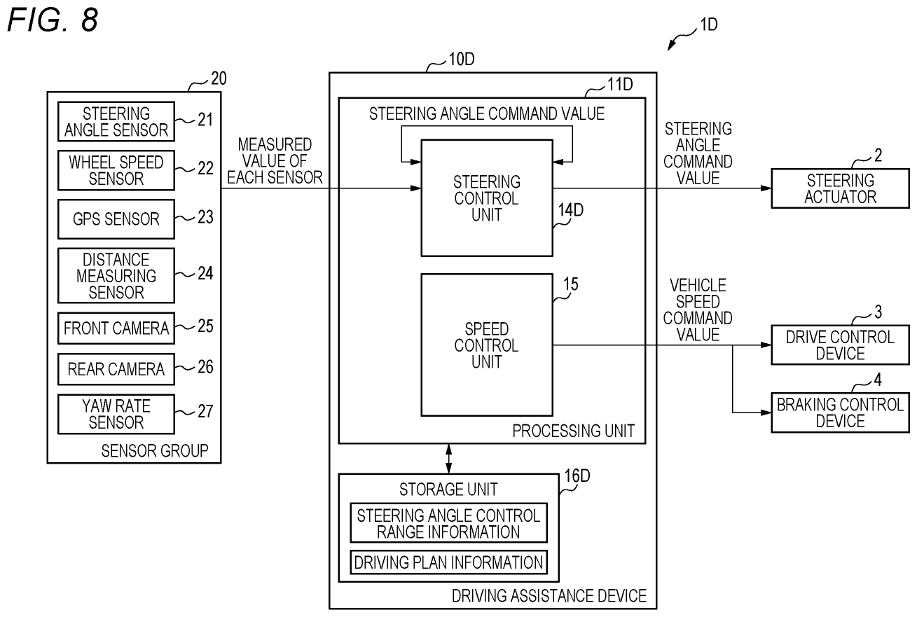

A control configuration of a vehicle 1D including a driving assistance device 10D according to the present embodiment will be described with reference to FIG. 8. FIG. 8 is a block diagram showing a control configuration of the vehicle 1D according to the present embodiment.

In the third embodiment, when the steering angle measured value acquired during manual driving falls outside the control range during automated driving, the steering angle control range is expanded. On the other hand, in the present embodiment, when a measured value during automated driving falls within the steering angle control range during automated driving and an absolute value of a steering angle command value during automated driving is larger than an absolute value of the steering angle measured value during automated driving, the steering angle control range during automated driving is reduced. For example, a control range of −580° to +580° is set to a control range of −550° to +550°.

As shown in FIG. 8, the driving assistance device 10D includes a processing unit 11D and a storage unit 16D in the present embodiment. The processing unit 11D includes a steering control unit 14D and the speed control unit 15. The processing unit 11D may include the host vehicle position estimation unit 12 and the driving plan generation unit 13.

The steering control unit 14D acquires a steering angle control range during automated driving of the vehicle 1D from the storage unit 16D, and acquires a steering angle measured value measured during automated driving of the vehicle 1D. As described in the first embodiment, the steering control unit 14D calculates and acquires a steering angle command value.

When the steering angle measured value during automated driving falls within the steering angle control range during automated driving, the steering control unit 14D compares an absolute value of the steering angle command value during automated driving with an absolute value of the steering angle measured value during automated driving. When the absolute value of the steering angle command value during automated driving is larger than the absolute value of the steering angle measured value during automated driving, a limit value (for example, an upper limit value or a lower limit value) of the steering angle control range during automated driving is changed to the steering angle measured value during automated driving of the vehicle 1D, and the steering angle control range is reduced.

The steering control unit 14D may reduce the steering angle control range in consideration of an update threshold. For example, the steering control unit 14D may reduce the steering angle control range when the number of times that the absolute value of the steering angle command value during automated driving is larger than the absolute value of the steering angle measured value during automated driving is equal to or larger than the update threshold during automated driving of the vehicle 1D. Accordingly, even when accuracy of a measured value is accidentally low, it is possible to prevent the steering angle control range from being erroneously reduced.

The steering control unit 14D may reduce the steering angle control range in consideration of a steering angle determination threshold. With regard to the steering angle determination threshold, in a case where the steering angle measured value during automated driving is excessively small, when the control range is reduced in accordance with the measured value, the control range may become excessively narrow. In order to avoid this problem, it is possible to set a value of a measured value suitable for a certain degree of reduction update as a limit value of a new steering angle control range during automated driving in consideration of the steering angle determination threshold.

The steering angle determination threshold includes a positive determination threshold and a negative determination threshold. The thresholds such as the positive determination threshold and the negative determination threshold may be stored in the storage unit 16D. For example, the positive determination threshold is a positive value, the negative determination threshold is a negative value, and absolute values of the positive determination threshold and the negative determination threshold are set to be the same. The present disclosure is not limited thereto. Alternatively, one threshold may be set to be smaller than the other threshold.

In the present embodiment, an updated control range is reduced as compared with a control range before the update. An actual operation range of a steering angle may be narrowed due to aging or deterioration. Even in this case, the steering angle control range during automated driving is set again to be close to an actual operation range of a steering angle based on the steering angle measured value, and the steering angle control range becomes a range corresponding to a change such as aging. That is, in a case where a steering angle in the vicinity of the limit value of the steering angle control range during automated driving cannot be realized by automated driving, the steering angle control range is reduced to be a control range corresponding to a change such as aging, and it is possible to perform traveling which is not suitable for the vehicle 1D in automated driving.

<Processing Flow of Steering Control Unit>

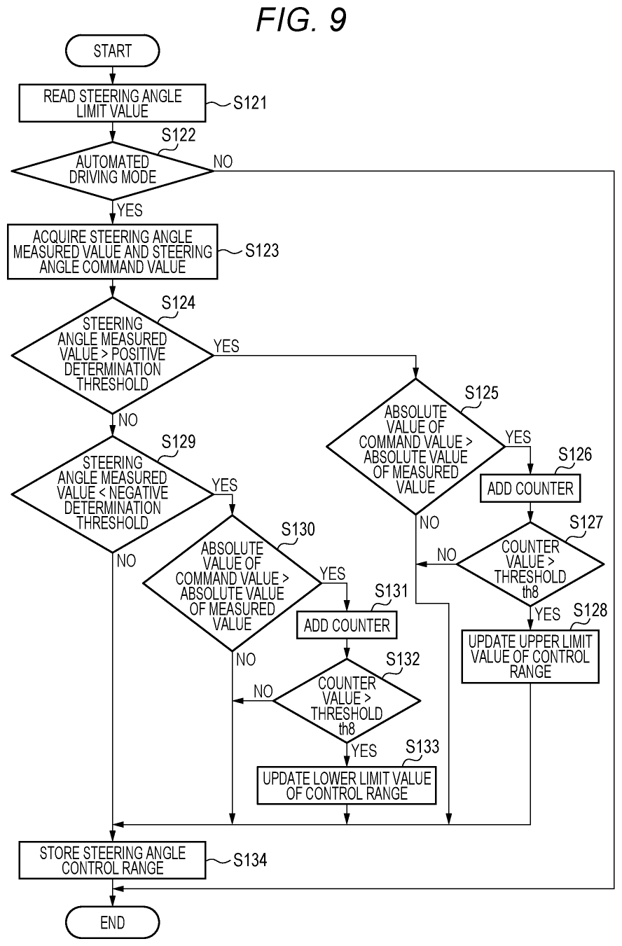

A processing flow of the steering control unit 14D will be described with reference to FIG. 9. FIG. 9 is a flowchart showing an example of a processing executed by the steering control unit 14D.

The steering control unit 14D reads the steering angle control range stored in the storage unit 16D (S121). The steering control unit 14D determines whether a driving mode is set to the automated driving mode (S122). As a result of the determination, when the steering control unit 14D determines that the vehicle is not set to the automated driving mode (NO in S122), the steering control unit 14D ends the processing. On the other hand, when it is determined that automated driving is started (YES in S122), the processing proceeds to step S123.

The steering control unit 14D acquires a steering angle measured value measured during automated driving of the vehicle 1D (S123). The steering control unit 14D calculates and acquires a steering angle command value (S123).

The steering control unit 14D determines whether the steering angle measured value is larger than the positive determination threshold (S124). As a result of the determination, when it is determined that the steering angle measured value is larger than the positive determination threshold (YES in S124), the steering control unit 14D determines whether an absolute value of the steering angle command value is larger than an absolute value of the measured value (S125). When it is determined that the absolute value of the command value is larger than the absolute value of the measured value (YES in S125), a counter variable is set in the steering control unit 14D, and the steering control unit 14D updates the counter variable by adding 1 that is a natural number to the counter variable (S126). On the other hand, when it is determined that the absolute value of the steering angle command value is equal to or smaller than the absolute value of the steering angle measured value (NO in S125), the steering control unit 14D stores the steering angle control range in the storage unit 16D without updating the steering angle control range (S134), and ends the processing (END).

The counter variable is a variable for counting the number of times that the absolute value of the steering angle command value is determined to be larger than the absolute value of the steering angle measured value.

The steering control unit 14D determines whether a value of the counter variable is larger than the update threshold (a threshold th8) (S127). When it is determined that the value of the counter variable is larger than the update threshold (YES in S127), the steering control unit 14D changes the upper limit value of the control range to the steering angle measured value and reduces the steering angle control range (S128). On the other hand, when it is determined that the value of the counter variable is equal to or smaller than the update threshold (NO in S127), the steering control unit 14D proceeds to step S134 and ends the processing (END).

When it is determined that the steering angle measured value is equal to or smaller than the positive determination threshold (NO in S124), the steering control unit 14D further determines whether the steering angle measured value is smaller than the negative determination threshold (S129). As a result of the determination, when it is determined that the steering angle measured value is equal to or larger than the negative determination threshold (NO in S129), the steering control unit 14D proceeds to step S134, and ends the processing after step S134 (END).

On the other hand, when it is determined that the steering angle measured value is smaller than the negative determination threshold th12 (YES in S129), the steering control unit 14D determines whether the absolute value of the steering angle command value is larger than the absolute value of the steering angle measured value (S130). When it is determined that the absolute value of the steering angle command value is larger than the absolute value of the steering angle measured value (YES in S130), the steering control unit 14D updates the counter variable by adding 1 that is a natural number to the counter variable (S131). On the other hand, when it is determined that the absolute value of the steering angle command value is equal to or smaller than the absolute value of the steering angle measured value (NO in S130), the steering control unit 14D stores the steering angle control range in the storage unit 16D without updating the steering angle control range (S134), and ends the processing (END).

The steering control unit 14D determines whether a value of the counter variable is larger than the update threshold (S132). When it is determined that the value of the counter variable is larger than the update threshold (YES in S132), the steering control unit 14D changes the lower limit value of the steering angle control range to the steering angle measured value and reduces the steering angle control range (S133). On the other hand, when it is determined that the value of the counter variable is equal to or smaller than the update threshold (NO in S132), the steering control unit 14D proceeds to step S134 and ends the processing after step S134 (END). The steering control unit 14D executes this series of processings during automated driving, and reduces the steering angle control range to immediately follow an actual operation range of the steering control unit 14D.

<Advantages of Fourth Embodiment>

As described above, the driving assistance device 10D according to the present embodiment includes the processing unit 11D, and the processing unit 11D includes the steering control unit 14D. The processing unit 11D acquires a steering angle measured value measured during automated driving of the vehicle 1D. When the steering angle measured value during automated driving of the vehicle 1D falls within the steering angle control range during automated driving and an absolute value of a steering angle command value during automated driving is larger than an absolute value of the steering angle measured value during automated driving, the processing unit 11D changes a limit value (for example, an upper limit value or a lower limit value) of the steering angle control range during automated driving to the steering angle measured value during automated driving of the vehicle 1D to reduce the steering angle control range during automated driving.

Therefore, in a case where an actual operation range of a steering angle during manual driving cannot be realized by steering during automated driving, the driving assistance device 10D can perform traveling that is not suitable for the vehicle 1D in automated driving in accordance with a change such as aging by reducing the steering angle control range during automated driving.

The processing unit 11D may compare the absolute value of the steering angle measured value during automated driving with the absolute value of the steering angle command value during automated driving. When the number of times that the absolute value of the steering angle command value during automated driving is larger than the absolute value of the steering angle measured value during automated driving is equal to or larger than the update threshold, the processing unit 11D may change the upper limit value or the lower limit value of the steering angle control range during automated driving to the steering angle measured value during automated driving of the vehicle 1D so as to reduce the steering angle control range during automated driving. Accordingly, the driving assistance device 10D can prevent unnecessary changes in the steering angle control range during automated driving.

When the absolute value of the steering angle measured value during automated driving of the vehicle 1D is larger than the absolute value of the steering angle determination threshold (an example of a threshold) and the absolute value of the steering angle command value during automated driving is larger than the absolute value of the steering angle measured value during automated driving, the processing unit 11D changes the upper limit value or the lower limit value of the steering angle control range during automated driving to the steering angle measured value during automated driving of the vehicle 1D so as to reduce the steering angle control range during automated driving. Accordingly, the driving assistance device 10D can prevent frequent reductions and changes of the steering angle control range during automated driving by changing a change timing of the steering angle control range during automated driving to a meaningful timing in a limited manner.

Although embodiments have been described above with reference to the drawings, it is needless to say that the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. Components in the embodiments described above may be optionally combined within a range not departing from the spirit of the invention.

Although a driving assistance device that assists traveling or parking in a narrow space is mainly described in the embodiments described above, the driving assistance device is not limited thereto, and the present disclosure is also applicable to a driving assistance device that assists general traveling.

In the embodiments described above, the processor may be physically implemented in any manner. When a programmable processor is used, processing contents can be changed by changing a program, and thus a degree of freedom in designing the processor can be improved. The processor may be implemented by one semiconductor chip or may be physically implemented by a plurality of semiconductor chips. In the case of a plurality of semiconductor chips, each control in the embodiments described above may be realized by a different semiconductor chip. In this case, it can be considered that one processor is configured with the plurality of semiconductor chips. The processor may be implemented by a member (a capacitor or the like) having a function different from a function of the semiconductor chip. One semiconductor chip may be configured to implement a function of the processor and another function. In addition, a plurality of processors may be implemented by one processor.

In the embodiments described above, each threshold may be a fixed value or a variable value. Each threshold may be a predetermined value or a value input via an operation unit provided in a vehicle or a driving assistance device.

Hereinafter, an outline of the third embodiment and the fourth embodiment will be described.

[Item 1] A driving assistance device for assisting driving of a vehicle, the driving assistance device including:

a processing unit,

wherein the processing unit is configured to:
acquire a steering angle measured value measured during manual driving of the vehicle;
acquire a steering angle control range during automated driving of the vehicle;
compare the steering angle measured value with the steering angle control range; and
update the steering angle control range so as to include the steering angle measured value in a case in which the steering angle measured value is not included in the steering angle control range.

[Item 2] The driving assistance device according to Item 1,

wherein the processing unit is configured to update a limit value of the steering angle control range to the steering angle measured value in a case in which the steering angle measured value is not included in the steering angle control range.

[Item 3] The driving assistance device according to Item 2,

wherein the processing unit is configured to update an upper limit value of the steering angle control range to the steering angle measured value in a case in which the steering angle measured value is not included in the steering angle control range.

[Item 4] The driving assistance device according to any one of Items 1 to 3 wherein the processing unit is configured to change a limit value of the steering angle control range to the steering angle measured value of the vehicle to expand the steering angle control range in a case in which the steering angle measured value of the vehicle falls outside the steering angle control range.

[Item 5] The driving assistance device according to Item 4,

wherein the processing unit is configured to:
sequentially acquire steering angle measured values that are sequentially measured during manual driving of the vehicle; and
sequentially compare the steering angle measured values with the steering angle control range.

[Item 6] The driving assistance device according to Item 4,

wherein the processing unit is configured to:
set a driving mode of the vehicle; and
compare the steering angle measured value with the steering angle control range in a case in which the driving mode of the vehicle is set to a learning mode in which a driving plan of automated driving is generated based on manual driving of the vehicle.

[Item 7] The driving assistance device according to any one of Items 4 to 6,

wherein the processing unit is configured to:
acquire map information;
acquire a route along which the vehicle travels by manual driving from the map information; and
compare the steering angle measured value with the steering angle control range in a case in which an average curvature of a predetermined section of the route is equal to or larger than a first threshold.

[Item 8] The driving assistance device according to any one of Items 4 to 7,

wherein the processing unit is configured to:
acquire a turning angular velocity during manual driving of the vehicle; and
compare the steering angle measured value with the steering angle control range in a case in which the turning angular velocity is equal to or larger than a third threshold.

[Item 9] The driving assistance device according to any one of Items 4 to 8, further including:

a storage unit

wherein the processing unit is configured to:
acquire a first traveling position at which the turning angular velocity of the vehicle that is equal to or larger than a fourth threshold is measured during manual driving of the vehicle, and store the first traveling position in the storage unit;
acquire a second traveling position at which the vehicle travels during manual driving of the vehicle; and
compare the steering angle measured value with the steering angle control range in a case in which a distance between the first traveling position and the second traveling position is smaller than a fifth threshold.

[Item 10] The driving assistance device according to any one of Items 1 to 3,

the processing unit is configured to:
acquire a steering angle measured value measured during automated driving of the vehicle;
acquire a steering angle command value during automated driving of the vehicle; and
change a limit value of the steering angle control range to the steering angle measured value of the vehicle to reduce the steering angle control range in a case in which the steering angle measured value during automated driving of the vehicle falls within the steering angle control range and an absolute value of the steering angle command value during automated driving is larger than an absolute value of the steering angle measured value during automated driving.

[Item 11] The driving assistance device according to Item 10,

wherein the processing unit is configured to:
change the limit value of the steering angle control range to the steering angle measured value during automated driving of the vehicle to reduce the steering angle control range in a case in which the number of times that the absolute value of the steering angle command value during automated driving is larger than the absolute value of the steering angle measured value during automated driving is equal to or larger than a sixth threshold.

[Item 12] The driving assistance device according to Item 10 or 11,

wherein the processing unit is configured to:
change the limit value of the steering angle control range to the steering angle measured value during automated driving to reduce the steering angle control range in a case in which an absolute value of the steering angle measured value during automated driving of the vehicle is larger than a seventh threshold and the absolute value of the steering angle command value during automated driving is larger than the absolute value of the steering angle measured value during automated driving.

[Item 13] A driving assistance method for assisting driving of a vehicle, the driving assistance method including:

acquiring a steering angle measured value measured during manual driving of the vehicle;

acquiring a steering angle control range during automated driving of the vehicle; comparing the steering angle measured value with the steering angle control range; and

updating the steering angle control range so as to include the steering angle measured value in a case in which the steering angle measured value is not included in the steering angle control range.

Although the present disclosure has been described in detail with reference to specific embodiments, it will be apparent to those skilled in the art that various changes and modifications can be made without departing from the spirit and scope of the present disclosure.

The present disclosure is based on Japanese Patent Application No. 2020-036297 filed on Mar. 3, 2020, and the contents thereof are incorporated herein as reference.

The present disclosure is useful for a driving assistance device, a driving assistance method, and the like capable of performing automated driving in accordance with a driving plan including a steering plan in which a steering angle exceeds a steering angle control range assumed in automated driving.

What is claimed is:

1. A driving assistance device for assisting parking of a vehicle by automated driving along a route on which a driver of the vehicle parks the vehicle in a parking area by manual driving, the driving assistance device comprising:
a processor,
wherein the processor is configured to:
acquire a steering angle measured value during manual driving of the vehicle;
acquire a steering angle control range during automated driving of the vehicle; and
determine a vehicle speed command value during automated driving of the vehicle based on a limit value of the steering angle control range in a case in which the steering angle measured value falls outside the steering angle control range.

2. The driving assistance device according to claim 1,
wherein the processor is configured to:
calculate a vehicle speed candidate value during automated driving of the vehicle based on the limit value of the steering angle control range in a case in which the steering angle measured value falls outside the steering angle control range; and
determine the vehicle speed candidate value as the vehicle speed command value in a case in which the vehicle speed candidate value satisfies a constraint condition based on the vehicle speed candidate value.

3. The driving assistance device according to claim 2,
wherein the processor is configured to:
acquire a vehicle speed measured value during automated driving of the vehicle;
calculate a turning angular velocity during automated driving of the vehicle based on the vehicle speed measured value during automated driving of the vehicle and the limit value of the steering angle control range during automated driving of the vehicle; and
calculate the vehicle speed candidate value during automated driving of the vehicle based on a ratio of the turning angular velocity to the vehicle speed measured value of the vehicle.

4. The driving assistance device according to claim 2,
wherein the processor is configured to:
acquire driving plan information of automated driving of the vehicle;
acquire a route which is included in the driving plan information and along which the vehicle travels;
calculate a route traveling time required for the vehicle to travel along the route based on the vehicle speed candidate value; and
determine that the constraint condition is satisfied in a case in which the route traveling time is equal to or less than a first threshold.

5. The driving assistance device according to claim 2,
wherein the processor is configured to:
acquire a pulse period of a rotor used in a wheel speed sensor provided in the vehicle; and
determine that the constraint condition is satisfied in a case in which the pulse period of the rotor corresponding to the vehicle speed candidate value is equal to or smaller than a second threshold.

6. The driving assistance device according to claim 2,
wherein the processor is configured to determine that the constraint condition is satisfied in a case in which the vehicle speed candidate value is larger than a third threshold corresponding to an upper limit value of a vehicle speed at which an idle creep occurs in the vehicle.

7. The driving assistance device according to claim 2,
wherein the processor is configured to:
acquire driving plan information of automated driving of the vehicle;
acquire host vehicle position information that is information indicating a position of the vehicle during automated driving of the vehicle;
calculate a scheduled vehicle speed command value during automated driving of the vehicle based on the driving plan information and the host vehicle position information; and
determine that the constraint condition is satisfied in a case in which the vehicle speed candidate value during automated driving of the vehicle is smaller than the scheduled vehicle speed command value.

8. The driving assistance device according to claim 1, further comprising:
a storage unit that stores driving plan information of automated driving of the vehicle,
wherein the processor is configured to update a vehicle speed planned value of the vehicle included in the driving plan information based on the vehicle speed command value during automated driving of the vehicle.

9. The driving assistance device according to claim 4,
wherein the processor is configured to:
acquire a traveling state measured value of the vehicle during manual driving of the vehicle; and
generate the driving plan information during automated driving of the vehicle based on the traveling state measured value of the vehicle during manual driving.

10. The driving assistance device according to claim 1,
wherein the driving assistance device is mounted on the vehicle.

11. The driving assistance device according to claim 7,
wherein the processing unit is configured to:
acquire a traveling state measured value of the vehicle during manual driving of the vehicle; and
generate the driving plan information during automated driving of the vehicle based on the traveling state measured value of the vehicle during manual driving.

12. The driving assistance device according to claim 8,
wherein the processing unit is configured to:
acquire a traveling state measured value of the vehicle during manual driving of the vehicle; and
generate the driving plan information during automated driving of the vehicle based on the traveling state measured value of the vehicle during manual driving.

13. The driving assistance device according to claim 2,
wherein the processor is configured to:
determine a scheduled vehicle speed command value during automated driving of the vehicle as a vehicle speed command value in a case in which the vehicle speed candidate value does not satisfy the constraint condition.

14. The driving assistance device according to claim 13,
wherein the processor is configured to:
acquire driving plan information of automated driving of the vehicle;
acquire host vehicle position information that is information indicating a position of the vehicle during automated driving of the vehicle;
calculate a scheduled vehicle speed command value during automated driving of the vehicle based on the driving plan information and the host vehicle position information.

15. The driving assistance device according to claim 13,
wherein the scheduled vehicle speed command value is a constant value.

16. The driving assistance device according to claim 13,
wherein the processor is configured to:
acquire driving plan information of automated driving of the vehicle, the driving plan information including a vehicle speed planned value,
wherein the scheduled vehicle speed command value is equal to the vehicle speed planned value.

17. The driving assistance device according to claim 3,
wherein the processor is configured to:
calculate, as the vehicle speed candidate value, a vehicle speed at which a value of the ratio is maximum.

18. The driving assistance device according to claim 3,
wherein the processor is configured to:
calculate, as the vehicle speed candidate value, a vehicle speed at which a value of the ratio is maximum under a predetermined condition.

19. A driving assistance method for assisting parking of a vehicle by automated driving along a route on which a driver of the vehicle parks the vehicle in a parking area by manual driving, the driving assistance method comprising:
acquiring a steering angle measured value during manual driving of the vehicle;
acquiring a steering angle control range during automated driving of the vehicle; and
determining a vehicle speed command value during automated driving of the vehicle based on a limit value of the steering angle control range in a case in which the steering angle measured value falls outside the steering angle control range.

20. A non-transitory computer-readable medium that stores a computer program, the computer program, when executed by a processor, causing a computer to perform a process for assisting parking of a vehicle by automated driving along a route on which a driver of the vehicle parks the vehicle in a parking area by manual driving, the process comprising:
acquiring a steering angle measured value during manual driving of the vehicle;
acquiring a steering angle control range during automated driving of the vehicle; and
determining a vehicle speed command value during automated driving of the vehicle based on a limit value of the steering angle control range in a case in which the steering angle measured value falls outside the steering angle control range.
